(19) United States
(12) Patent Application Publication
(10) Pub. No.: US 2026/0279653 A1
(43) Pub. Date: Sep. 17, 2026

(54) INDUCTOR ELEMENT AND INDUCTOR COMPONENT

(71) Applicant: Murata Manufacturing Co., Ltd., Kyoto-fu (JP)

(72) Inventors: Yoshimasa YOSHIOKA, Nagaokakyo-shi (JP); Yuuki KAWAKAMI, Nagaokakyo-shi (JP); Kojiro KOMAGAKI, Nagaokakyo-shi (JP); Masashi HATTORI, Nagaokakyo-shi (JP)

(73) Assignee: Murata Manufacturing Co., Ltd., Kyoto-fu (JP)

(21) Appl. No.: 19/669,278

(22) Filed: May 6, 2026

Related U.S. Application Data
(63) Continuation of application No. PCT/JP2024/019318, filed on May 27, 2024.

(30) Foreign Application Priority Data
Nov. 9, 2023 (JP) 2023-191738

(51) Int. Cl. H01F 27/28; H01F 27/24

(52) U.S. Cl. CPC H01F 27/2804; H01F 27/24; H01F 2027/2809

(57) ABSTRACT

An inductor element includes a magnetic layer provided along a first imaginary plane and having uniaxial magnetic anisotropy, and an inductor wire spaced apart from the first imaginary plane in a first direction that intersects the first imaginary plane. The inductor wire is provided along a second imaginary plane that is parallel to the first imaginary plane. A roughness of a planar portion of the magnetic layer located on the first imaginary plane is greater than or equal to 3 nm and less than or equal to 10 nm (i.e., from 3 nm to 10 nm).

### CROSS-REFERENCE TO RELATED APPLICATIONS

This application claims benefit of priority to International Patent Application No. PCT/JP2024/019318, filed May 27, 2024, and to Japanese Patent Application No. 2023-191738, filed Nov. 9, 2023, the entire contents of each are incorporated herein by reference.

### BACKGROUND

### Technical Field

The present disclosure relates to an inductor element, and an inductor component including the inductor element.

### Background Art

Japanese Unexamined Patent Application Publication No. 2000-252127 discloses a wire-wound magnetic thin film inductor. In the inductor disclosed in Japanese Unexamined Patent Application Publication No. 2000-252127, magnetic thin films are formed on a glass substrate.

### SUMMARY

In the inductor disclosed in Japanese Unexamined Patent Application Publication No. 2000-252127, no consideration is given to achieving both ensuring the adhesion of the magnetic layers and improving the efficiency of obtaining inductance.

Accordingly, the present disclosure provides an inductor element and an inductor component that can improve the efficiency of obtaining inductance while ensuring the adhesion of the magnetic layer.

An inductor element according to an aspect of the present disclosure includes a magnetic layer provided along a first imaginary plane, the magnetic layer having uniaxial magnetic anisotropy; and an inductor wire spaced apart from the first imaginary plane in a first direction that intersects the first imaginary plane, the inductor wire being provided along a second imaginary plane that is parallel to the first imaginary plane. A roughness of a planar portion of the magnetic layer located on the first imaginary plane is greater than or equal to 3 nm and less than or equal to 10 nm (i.e., from 3 nm to 10 nm).

An inductor component according to an aspect of the present disclosure includes the inductor element according to the above aspect; and an external terminal electrically connected to the inductor wire.

With the inductor element and the inductor component according to the above aspect, it is possible to realize an inductor element and an inductor component that can improve the efficiency of obtaining inductance while ensuring the adhesion of the magnetic layer.

### BRIEF DESCRIPTION OF THE DRAWINGS

FIG. 1 is a schematic plan view that shows an inductor component including an inductor element according to a first embodiment of the present disclosure;

FIG. 2 is a schematic cross-sectional view taken along the line X1-X2 in FIG. 1;

FIG. 3 is a schematic cross-sectional view taken along the line Y1-Y2 in FIG. 1;

FIG. 4 is a graph that shows an example of the B-H curve of a magnetic layer of the inductor component shown in FIG. 1;

FIG. 5 is a first schematic cross-sectional view for illustrating an example of a manufacturing method for the inductor component shown in FIG. 1;

FIG. 6 is a second schematic cross-sectional view for illustrating an example of the manufacturing method for the inductor component shown in FIG. 1;

FIG. 7 is a third schematic cross-sectional view for illustrating an example of the manufacturing method for the inductor component shown in FIG. 1;

FIG. 8 is a fourth schematic cross-sectional view for illustrating an example of the manufacturing method for the inductor component shown in FIG. 1;

FIG. 9 is a fifth schematic cross-sectional view for illustrating an example of the manufacturing method for the inductor component shown in FIG. 1;

FIG. 10 is a sixth schematic cross-sectional view for illustrating an example of the manufacturing method for the inductor component shown in FIG. 1;

FIG. 11 is a seventh schematic cross-sectional view for illustrating an example of the manufacturing method for the inductor component shown in FIG. 1;

FIG. 12 is an eighth schematic cross-sectional view for illustrating an example of the manufacturing method for the inductor component shown in FIG. 1;

FIG. 13 is a ninth schematic cross-sectional view for illustrating an example of the manufacturing method for the inductor component shown in FIG. 1;

FIG. 14 is a tenth schematic cross-sectional view for illustrating an example of the manufacturing method for the inductor component shown in FIG. 1;

FIG. 15 is an eleventh schematic cross-sectional view for illustrating an example of the manufacturing method for the inductor component shown in FIG. 1;

FIG. 16 is a twelfth schematic cross-sectional view for illustrating an example of the manufacturing method for the inductor component shown in FIG. 1;

FIG. 17 is a table that shows the relationship between the roughness of a planar portion of a magnetic layer of the inductor component shown in FIG. 1 and the CTE of an electrically insulating layer that is in direct contact with the planar portion;

FIG. 18 is a schematic plan view that shows a first modification of the inductor component shown in FIG. 1;

FIG. 19 is a schematic cross-sectional view that shows a second modification of the inductor component shown in FIG. 1;

FIG. 20 is a cross-sectional view taken along the line Z1-Z2 in FIG. 19;

FIG. 21 is a schematic plan view that shows a third modification of the inductor component shown in FIG. 1;

FIG. 22 is a schematic cross-sectional view that shows a fourth modification of the inductor component shown in FIG. 1;

FIG. 23 is a first view for illustrating an example of a method of forming a magnetic layer of an inductor component shown in FIG. 22;

FIG. 24 is a second view for illustrating an example of a method of forming the magnetic layer of the inductor component shown in FIG. 22;

FIG. 25 is a first view for illustrating an example of a method of forming a magnetic layer different from that of the inductor component shown in FIG. 22;

FIG. 26 is a second view for illustrating an example of a method of forming a magnetic layer different from that of the inductor component shown in FIG. 22;

FIG. 27 is a schematic plan view that shows an inductor component including an inductor element according to a second embodiment of the present disclosure;

FIG. 28 is a cross-sectional view taken along the line D1-D2 in FIG. 27;

FIG. 29 is a graph that shows an example of the B-H curve of a magnetic layer of the inductor component shown in FIG. 27;

FIG. 30 is a first schematic cross-sectional view for illustrating an example of a manufacturing method for the inductor component shown in FIG. 27;

FIG. 31 is a second schematic cross-sectional view for illustrating an example of the manufacturing method for the inductor component shown in FIG. 27;

FIG. 32 is a third schematic cross-sectional view for illustrating an example of the manufacturing method for the inductor component shown in FIG. 27;

FIG. 33 is a fourth schematic cross-sectional view for illustrating an example of the manufacturing method for the inductor component shown in FIG. 27;

FIG. 34 is a fifth schematic cross-sectional view for illustrating an example of the manufacturing method for the inductor component shown in FIG. 27;

FIG. 35 is a sixth schematic cross-sectional view for illustrating an example of the manufacturing method for the inductor component shown in FIG. 27;

FIG. 36 is a seventh schematic cross-sectional view for illustrating an example of the manufacturing method for the inductor component shown in FIG. 27;

FIG. 37 is an eighth schematic cross-sectional view for illustrating an example of the manufacturing method for the inductor component shown in FIG. 27;

FIG. 38 is a ninth schematic cross-sectional view for illustrating an example of the manufacturing method for the inductor component shown in FIG. 27;

FIG. 39 is a tenth schematic cross-sectional view for illustrating an example of the manufacturing method for the inductor component shown in FIG. 27;

FIG. 40 is an eleventh schematic cross-sectional view for illustrating an example of the manufacturing method for the inductor component shown in FIG. 27;

FIG. 41 is a twelfth schematic cross-sectional view for illustrating an example of the manufacturing method for the inductor component shown in FIG. 27;

FIG. 42 is a schematic plan view that shows a first modification of the inductor component shown in FIG. 27;

FIG. 43 is a cross-sectional view taken along the line E1-E2 in FIG. 42;

FIG. 44 is a schematic cross-sectional view that shows a second modification of the inductor component shown in FIG. 27;

FIG. 45 is a schematic cross-sectional view that shows a third modification of the inductor component shown in FIG. 27;

FIG. 46 is a schematic cross-sectional view that shows a fourth modification of the inductor component shown in FIG. 27;

FIG. 47 is a cross-sectional view taken along the line F1-F2 in FIG. 46;

FIG. 48 is a cross-sectional view taken along the line G1-G2 in FIG. 46;

FIG. 49 is a first schematic cross-sectional view that shows a fifth modification of the inductor component shown in FIG. 27;

FIG. 50 is a second schematic cross-sectional view that shows the fifth modification of the inductor component shown in FIG. 27; and

FIG. 51 is a schematic cross-sectional view that shows a sixth modification of the inductor component shown in FIG. 27.

### DESCRIPTION OF EMBODIMENTS

Various aspects of the present disclosure will be described.

An inductor element according to a first aspect includes a magnetic layer provided along a first imaginary plane, the magnetic layer having uniaxial magnetic anisotropy; and an inductor wire spaced apart from the first imaginary plane in a first direction that intersects the first imaginary plane, the inductor wire being provided along a second imaginary plane that is parallel to the first imaginary plane. A roughness of a planar portion of the magnetic layer located on the first imaginary plane is greater than or equal to 3 nm and less than or equal to 10 nm (i.e., from 3 nm to 10 nm).

With the inductor element according to the first aspect, it is possible to improve the efficiency of obtaining inductance while ensuring the adhesion of the magnetic layer. For example, when the roughness of the planar portion of the magnetic layer is less than 3 nm, the contact area of the magnetic layer reduces, with the result that the adhesion decreases. When the roughness of the planar portion of the magnetic layer is greater than 10 nm, the crystal structure of magnetic material included in the magnetic layer becomes random, and the uniaxial magnetic anisotropy of the magnetic layer collapses, so there is a possibility that the efficiency of obtaining inductance cannot be improved.

According to a second aspect, in the inductor element according to the first aspect, the planar portion has the same roughness over an entire surface.

With the inductor element according to the second aspect, a patterning step is unnecessary, so the manufacturing cost of the inductor element can be reduced.

According to a third aspect, in the inductor element according to the first aspect or the second aspect, a portion of the inductor wire located on the second imaginary plane has a roughness greater than the roughness of the planar portion.

With the inductor element according to the third aspect, it is possible to enhance the adhesion of the inductor wire.

According to a fourth aspect, the inductor element according to any of the first to third aspects further includes an element body within which the magnetic layer and the inductor wire are located. The element body includes an electrically insulating layer that is in direct contact with the planar portion, and a CTE of the electrically insulating layer is higher than or equal to 2 ppm/° C. and lower than or equal to 60 ppm/° C. (i.e., from 2 ppm/° C. to 60 ppm/° C.).

With the inductor element according to the fourth aspect, the efficiency of obtaining inductance can be more reliably improved. For example, when the CTE of the electrically insulating layer is higher than 60 ppm/° C., and assuming that the magnetic layer is a multilayer body formed by sputtering, strain occurs during a heat treatment that is applied when the magnetic layer is formed, with the result that the crystal structure of the magnetic layer becomes random. In this case, the uniaxial magnetic anisotropy of the magnetic layer collapses, so there is a possibility that the efficiency of obtaining inductance cannot be improved.

According to a fifth aspect, the inductor element according to any one of the first to third aspects further includes an element body within which the magnetic layer and the inductor wire are located. The element body includes an electrically insulating layer that is in direct contact with the planar portion, and a CTE of the electrically insulating layer is higher than or equal to 2 ppm/° C. and lower than or equal to 35 ppm/° C. (i.e., from 2 ppm/° C. to 35 ppm/° C.).

With the inductor element according to the fifth aspect, the efficiency of obtaining inductance can be even more reliably improved.

According to a sixth aspect, the inductor element according to any one of the first to fifth aspects further includes an element body within which the magnetic layer and the inductor wire are located, and the element body includes an inorganic material substrate.

With the inductor element according to the sixth aspect, for example, when the element body includes an inorganic material substrate, such as an Si substrate, glass substrate, and ceramic substrate, harder than an organic resin, the strength of the element body can be improved.

According to a seventh aspect, in the inductor element according to the sixth aspect, the inorganic material substrate has a roughness less than the roughness of the planar portion.

With the inductor element according to the seventh aspect, the roughness of the electrically insulating layer of the element body can be easily adjusted.

An inductor component according to an eighth aspect includes the inductor element according to any one of the first to seventh aspects; and an external terminal electrically connected to the inductor wire.

With the inductor component according to the eighth aspect, it is possible to realize an inductor component that can be easily mounted on a circuit board.

According to a ninth aspect, in the inductor component according to the eighth aspect, the inductor wire is a first inductor wire located on one side of the magnetic layer in the first direction. The inductor element includes a second inductor wire located on the other side of the magnetic layer in the first direction, and a via portion electrically connecting the first inductor wire and the second inductor wire. The first inductor wire, the second inductor wire, and the via portion constitute at least part of an inductor wound around an axis extending along a second direction that intersects the first direction.

With the inductor component according to the ninth aspect, since the inductor is wound around the magnetic layer, the magnetic flux density passing through the magnetic layer increases, so the inductor component having a high quality factor can be realized.

According to a tenth aspect, in the inductor component according to the ninth aspect, an absolute value of an angle formed between a hard axis or easy axis of the magnetic layer and the axis is larger than or equal to zero degrees and smaller than 10 degrees.

With the inductor component according to the tenth aspect, since most of the magnetic flux is oriented toward the anisotropy axis, the efficiency of obtaining inductance can be improved, and the direct-current superposition characteristics can be improved. Since the first inductor wire formed along the imaginary plane, the second inductor wire, and the first via portion constitute part of the inductor, the inductor component can be easily miniaturized (for example, reduced in thickness).

According to an eleventh aspect, in the inductor component according to the ninth aspect or the tenth aspect, the magnetic layer has a first end portion facing the via portion in a third direction that intersects the first direction and the second direction, the via portion has a second end portion facing the magnetic layer in the third direction, and the first end portion and the second end portion are inclined in the same direction relative to the first direction.

With the inductor component according to the eleventh aspect, since the first end portion of the magnetic layer and the second end portion of the first via portion can be brought close to each other, the inductor can be miniaturized. For this reason, a miniaturizable inductor component can be realized. By bringing the first end portion of the magnetic layer and the second end portion of the first via portion close to each other, the volume of the magnetic layer can be increased. Therefore, the efficiency of obtaining inductance can be improved.

An inductor component according to a twelfth aspect includes the inductor element according to the sixth aspect or the seventh aspect; a pad portion provided at the end of the inductor wire; and a vertical wire connecting the pad portion and an external terminal.

With the inductor component according to the twelfth aspect, by using the vertical wire, a portion extended from the side surface of the inductor component to the external terminal becomes unnecessary, so the footprint of the inductor component can be reduced. As a result, the inductor component can be miniaturized.

According to a thirteenth aspect, the inductor component according to the twelfth aspect further includes a first magnetic layer that is the magnetic layer; and a second magnetic layer provided along a third imaginary plane parallel to the first imaginary plane and the second imaginary plane, the second imaginary plane being located between the first imaginary plane and the third imaginary plane in the first direction.

With the inductor component according to the thirteenth aspect, it is possible to reduce leakage flux and improve the efficiency of obtaining inductance.

According to a fourteenth aspect, in the inductor component according to the twelfth aspect or the thirteenth aspect, the inductor wire includes a plurality of layers disposed along the first direction.

With the inductor component according to the fourteenth aspect, the line length of the inductor can be increased, so the flexibility of coupling design can be improved.

According to a fifteenth aspect, in the inductor component according to the thirteenth aspect or the fourteenth aspect, one of the first magnetic layer and the second magnetic layer has a non-planar portion with a convex shape or a concave shape relative to the first imaginary plane or the second imaginary plane.

With the inductor component according to the fifteenth aspect, it is possible to reduce leakage flux and improve the efficiency of obtaining inductance.

According to a sixteenth aspect, in the inductor component according to any one of the thirteenth to fifteenth aspects, a roughness of the planar portion of the first magnetic layer and a roughness of a planar portion of the second magnetic layer located on the third imaginary plane are different.

With the inductor component according to the sixteenth aspect, the flexibility in selecting a material for the magnetic layer can be improved. As a result, for example, the strength and adhesion of the element body can be improved.

Hereinafter, embodiments of the present disclosure will be described with reference to the drawings. The following description does not limit the present disclosure and is merely illustrative in nature. Various modifications may be made as needed without departing from the spirit of the present disclosure. The drawings are schematic, and the dimensional ratios and the like may differ from those of the actual structure.

### First Embodiment

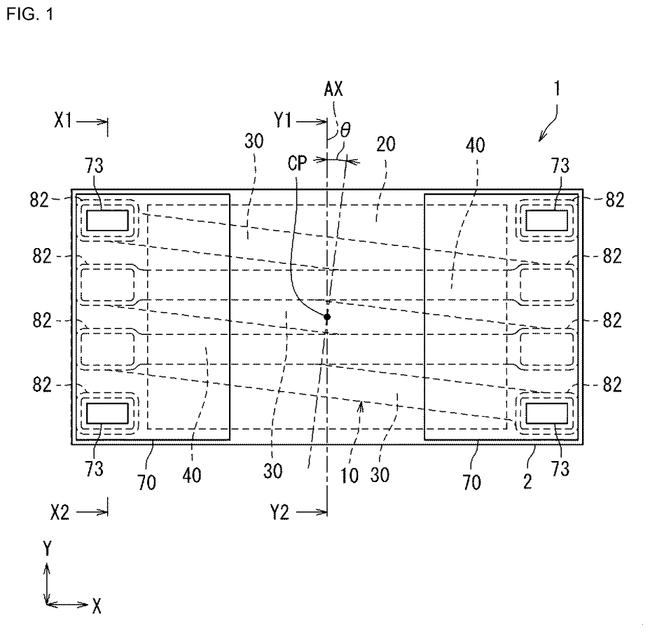

As shown in FIG. 1, an inductor component 1 according to a first embodiment of the present disclosure includes an inductor element 10. The inductor element 10 includes a magnetic layer 20 and first inductor wires 30.

As shown in FIGS. 1 to 3, in the present embodiment, the inductor element 10 further includes second inductor wires 40 and first via portions 50, and the inductor component 1 further includes an element body 2, second via portions 60, external terminals 70, and pad portions 81 and 82. The inductor element 10, the second via portions 60, and the pad portions 81 and 82 are located within the element body 2, and the external terminals 70 are located outside the element body 2. The pad portions 81 and 82 may constitute parts of the first inductor wires 30 and the second inductor wires 40, respectively, or may be configured separately from the first inductor wires 30 and the second inductor wires 40.

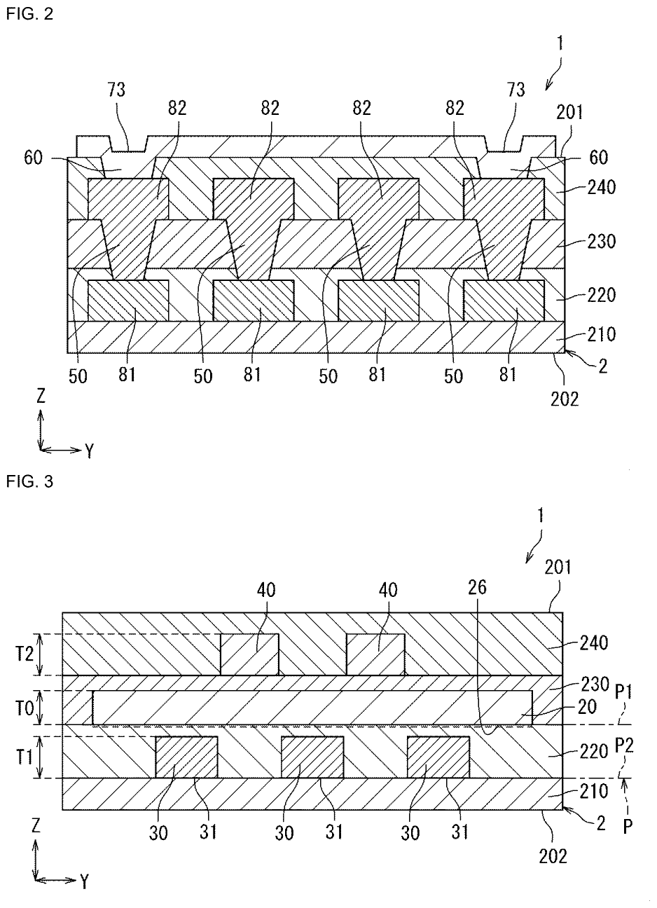

As an example, the element body 2 has a substantially rectangular parallelepiped shape. The height direction of the element body 2 is defined as a first direction (for example, a Z direction), the short-side direction of the element body 2 when viewed along the first direction Z is defined as a second direction (for example, a Y direction), and the long-side direction of the element body 2 when viewed along the first direction Z is defined as a third direction (for example, an X direction). As shown in FIGS. 2 and 3, the element body 2 has a first main surface 201 and a second main surface 202 respectively located at opposite ends in the first direction Z.

The element body 2 includes four electrically insulating layers 210, 220, 230, and 240 sequentially laminated along the first direction Z. The electrically insulating layer 220 is an example of a first electrically insulating layer and covers the first inductor wires 30 and the pad portions 81. The electrically insulating layer 230 covers the magnetic layer 20. The electrically insulating layer 240 covers the second inductor wires 40 and the pad portions 82. The first main surface 201 is constituted by the outer surface of the electrically insulating layer 240 in the first direction Z, and the second main surface 202 is constituted by the outer surface of the electrically insulating layer 210 in the first direction Z. The electrically insulating layer 210 is an example of a second electrically insulating layer located farther from the magnetic layer 20 in the first direction Z than the electrically insulating layer 220 and having a lower coefficient of linear expansion than the electrically insulating layer 220.

Each of the electrically insulating layers 210, 220, 230, and 240 includes epoxy, polyimide, phenolic, or a combination of these materials. The electrically insulating layer 210 may include an electrical insulation filler or may include an inorganic electrical insulator, such as SiO₂ and TaO. In an example, the electrically insulating layer 220 is in direct contact with a planar portion 26 of the magnetic layer 20 (described later), and has a coefficient of thermal expansion (CTE) of higher than or equal to 2 ppm/° C. and lower than or equal to 60 ppm/° C. (i.e., from 2 ppm/° C. to 60 ppm/° C.).

As an example, the inductor element 10 includes three first inductor wires 30, two second inductor wires 40, and six first via portions 50. The first inductor wires 30, the second inductor wires 40, and the first via portions 50 constitute at least part of a so-called helical inductor (coil) wound around an axis AX extending along the second direction Y. The helical shape refers to a shape in which the total number of turns of a coil is greater than one; however, the number of turns of the coil in a cross section orthogonal to the axis AX is less than one. “One turn or more” refers to a state in which the wire of the coil has radially adjacent portions in a cross section orthogonal to the axis AX. “Less than one turn” refers to a state in which the wire of the coil does not have radially adjacent portions in a cross section orthogonal to the axis AX.

The magnetic layer 20 has uniaxial magnetic anisotropy. In the present embodiment, the magnetic layer 20 has a rectangular shape when viewed along the first direction Z and is located inside the outer periphery of the inductor component 1. The term “rectangular shape” includes a substantially rectangular shape. The outer periphery of the inductor component 1 is, for example, the outer periphery of the element body 2. Eight pad portions 81 and 82 are located on each side of the magnetic layer 20 in the long-side direction of the magnetic layer 20. The pad portions 81 are located on the same side as the first inductor wires 30 relative to the magnetic layer 20, and the pad portions 82 are located on the same side as the second inductor wires 40 relative to the magnetic layer 20.

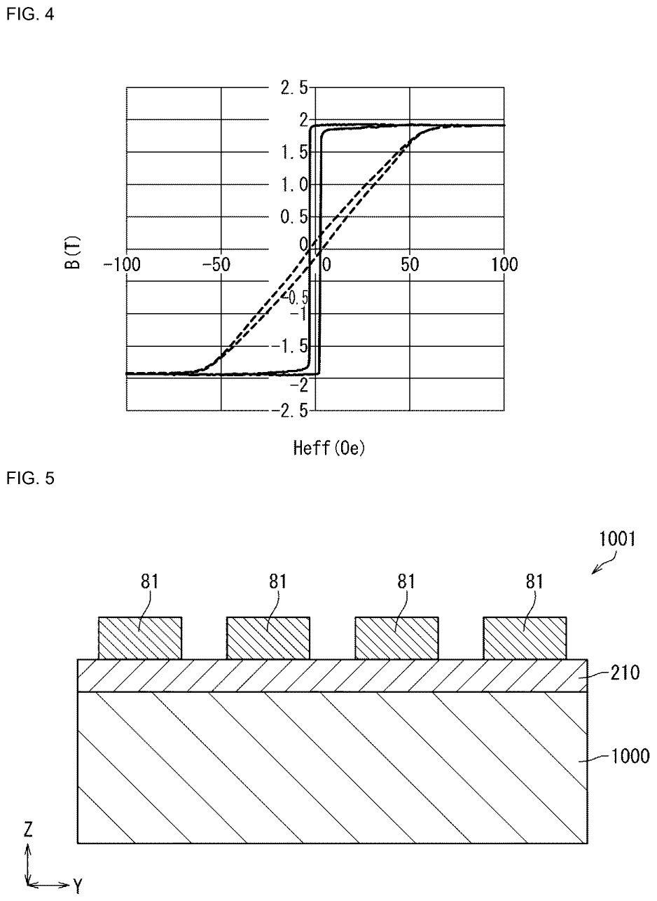

An example of the B-H curve of the magnetic layer 20 is shown in FIG. 4. In FIG. 4, the easy axis is represented by a solid line, and the hard axis is represented by a dashed line. As a method of measuring the hard-axis direction and easy-axis direction of uniaxial magnetic anisotropy, for example, there is a method in which a B-H curve of the magnetic layer 20 is measured using a vibrating sample magnetometer (VSM). In this method, B-H curves are measured with the sample rotated by 90 degrees, and the direction corresponding to the steeper B-H curve is taken as the easy axis, and the direction corresponding to the flatter B-H curve is taken as the hard axis. To eliminate the influence of shape anisotropy, an O-shaped or square-shaped sample is preferably used; however, samples having other shapes may also be used.

As shown in FIG. 3, the magnetic layer 20 is provided along a first imaginary plane P1. In the present embodiment, the first imaginary plane P1 is a plane (for example, an XY plane) that extends in a direction intersecting the height direction (for example, the first direction Z) of the element body 2 and that is located at the boundary between the electrically insulating layer 220 and the electrically insulating layer 230. The magnetic layer 20 has the planar portion 26 located at the first imaginary plane P1. The planar portion 26 is configured to have a roughness greater than or equal to 3 nm and less than or equal to 10 nm (i.e., from 3 nm to 10 nm). The “roughness” is, for example, the arithmetic mean surface roughness Ra obtained over a range of 10 μm of the planar portion 26. The arithmetic mean surface roughness Ra is obtained in accordance with JIS B 0601, for example, using a laser microscope VK-X1000 manufactured by Keyence Corporation. When it is difficult to obtain the roughness from a direction perpendicular to the planar portion 26, the line edge roughness (LER) obtained from a cross section perpendicular to the planar portion 26 may be used as the “roughness” of the planar portion 26.

The magnetic layer 20 is configured such that the absolute value of the angle θ (see FIG. 1) formed between the hard axis or easy axis and the axis AX is larger than or equal to zero degrees and smaller than 10 degrees (for example, such that the hard axis or easy axis and the axis AX are substantially parallel to each other). For example, it is assumed that the easy axis extends along the short-side direction (that is, the second direction Y) of the magnetic layer 20 and the hard axis extends along the long-side direction (that is, the third direction X) of the magnetic layer 20. In this case, the absolute value of the angle formed between the easy axis of the magnetic layer 20 and the axis AX is larger than or equal to zero degrees and smaller than 10 degrees (i.e., from zero degrees to smaller than 10 degrees). For example, it is assumed that the easy axis extends along the long-side direction (that is, the third direction X) of the magnetic layer 20 and the hard axis extends along the short-side direction (that is, the second direction Y) of the magnetic layer 20. In this case, the absolute value of the angle formed between the hard axis of the magnetic layer 20 and the axis AX is larger than or equal to zero degrees and smaller than 10 degrees (i.e., from zero degrees to smaller than 10 degrees).

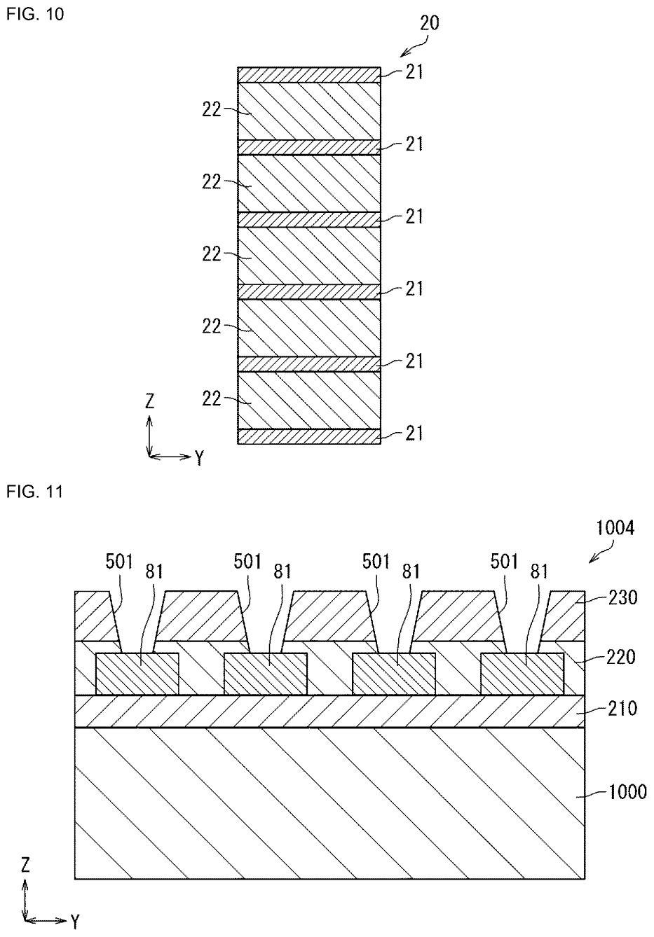

The magnetic layer 20 includes inorganic electrically insulating layers 21 and inorganic magnetic layers 22 laminated along the first direction Z (see FIG. 10). As an example, the magnetic layer 20 is composed of six inorganic electrically insulating layers 21 and five inorganic magnetic layers 22. The inorganic electrically insulating layers 21 are respectively located at opposite ends of the magnetic layer 20 in the first direction Z. Each of the inorganic electrically insulating layers 21 includes, for example, TaO or SiO₂. The inorganic magnetic layer 22 includes, for example, Co—Zr—Ta (CZT) or FeNi alloy. When the thickness of the inorganic magnetic layer 22 is increased, eddy currents may occur within the magnetic layer 20. For this reason, the inorganic magnetic layer 22 is configured to be thinner than the skin depth derived from the circuit operating frequency (for example, the switching frequency in the case of a DC-DC converter).

As shown in FIG. 3, the magnetic layer 20 is configured such that the thickness T0, which is a dimension in the first direction Z, is less than the thickness T1 of the first inductor wire 30 and the thickness T2 of the second inductor wire 40.

Each of the first inductor wires 30 is located on one side of the magnetic layer 20 in the first direction Z and extends along an imaginary plane P that intersects the first direction Z. Each of the second inductor wires 40 is located on the other side of the magnetic layer 20 in the first direction Z. In the present embodiment, the imaginary plane P is located at the boundary between the electrically insulating layers 210 and 220 of the element body 2.

As shown in FIG. 1, each of the first inductor wires 30 connects one of the four pad portions 81 located on one side of the magnetic layer 20 in the third direction X to one of the four pad portions 81 located on the other side of the magnetic layer 20 in the third direction X, when viewed along the first direction Z and a direction from the second inductor wires 40 to the first inductor wires 30. Each of the first inductor wires 30 connects two pad portions 81 at different positions in the second direction Y, and is inclined relative to the axis AX. Three first inductor wires 30 extend substantially parallel to one another. As shown in FIG. 3, the first inductor wires 30 are provided along a second imaginary plane P2. The second imaginary plane P2 is spaced apart from the first imaginary plane P1 in the first direction Z and extends parallel to the first imaginary plane P1. The term “parallel” includes “substantially parallel”.

As shown in FIG. 1, each of the second inductor wires 40 connects one of the four pad portions 82 located on one side of the magnetic layer 20 in the third direction X to twenty one of the four pad portions 82 located on the other side of the magnetic layer 20 in the third direction X, when viewed along the first direction Z and a direction from the second inductor wires 40 to the first inductor wires 30. Each of the second inductor wires 40 connects two pad portions 82 that are substantially in the same position in the second direction Y and is substantially orthogonal to the axis AX. Two second inductor wires 40 extend substantially parallel to each other.

The first inductor wires 30 and the second inductor wires 40 include, for example, a good conductor material, such as copper, silver, gold, and alloys of these materials. The first inductor wires 30 and the second inductor wires 40 may be a metal film formed by, for example, plating, vapor deposition, sputtering, or the like, or may be a metal sintered body formed by applying a conductor paste and sintering the conductor paste. Each of the first inductor wires 30 and the second inductor wires 40 may have a multilayer structure in which a plurality of metal layers is laminated. Each of the first inductor wires 30 and the second inductor wires 40 is configured not to be thicker than the thickness of the magnetic layer 20. With this configuration, an inductor component with low direct-current resistance and high efficiency of obtaining inductance can be realized.

Each of the first via portions 50 electrically connects the first inductor wire 30 and the second inductor wire 40. In the present embodiment, as shown in FIG. 2, the first via portion 50 extends along the first direction Z and connects the pair of pad portions 81 and 82 that are at substantially the same position in the first direction Z.

The second via portion 60 electrically connects at least one of the first inductor wire 30 and the second inductor wire 40 to the external terminal 70. In the present embodiment, as shown in FIG. 2, the second via portions 60 extend along the first direction Z and connect the pad portions 82 located at opposite ends in the second direction Y to the external terminal 70. Through this connection, the second inductor wire 40 is electrically connected to the external terminal 70.

The external terminal 70 is located on the first main surface 201 of the element body 2. In the present embodiment, the inductor component 1 includes two external terminals 70. Each of the external terminals 70 includes a base layer and a plating layer covering the base layer, and is disposed so as to cover four pad portions 82 that are located on the same side in the third direction X relative to the magnetic layer 20 when viewed along the first direction Z. As shown in FIG. 2, each of the external terminals 70 has four recessed portions 73 corresponding to the four pad portions 82. Each of the recessed portions 73 is provided at a position overlapping the pad portion 82 when viewed along the first direction Z, and is recessed toward the magnetic layer 20.

The first via portion 50, the second via portion 60, and the base layer of the external terminal 70 include, for example, an electrically conductive material, such as Ni and Sn. Each of the first via portions 50 and the second via portions 60 may be composed of a single layer of an electrically conductive material or may be composed of a plurality of layers of an electrically conductive material. The external terminal 70 may be composed of a single layer of an electrically conductive material.

As shown in FIG. 1, each of the components that constitute the inductor component 1 is symmetrically disposed relative to the central point CP of the element body 2 on the axis AX when viewed along the first direction Z.

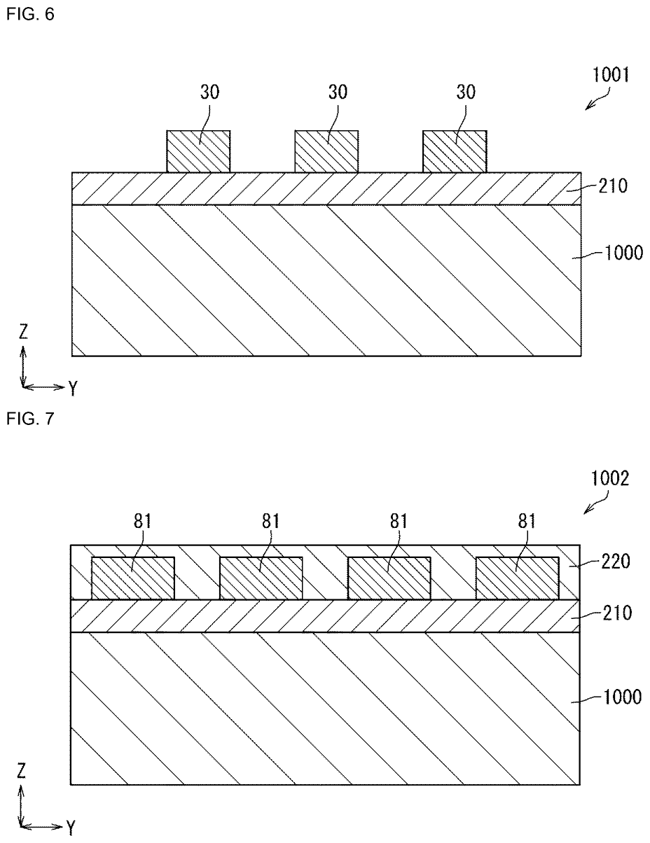

An example of a manufacturing method for the inductor component 1 will be described with reference to FIGS. 2, 3, and 5 to 16. FIGS. 5, 7, 11, 13, and 15 are drawings corresponding to the cross section taken along the line X1-X2 in FIG. 1, and FIGS. 6, 8 to 10, 12, 14, and 16 are drawings corresponding to the cross section taken along the line Y1-Y2 in FIG. 1.

As shown in FIGS. 5 and 6, the electrically insulating layer 210 is formed on a substrate 1000, and the first inductor wires 30 and the pad portions 81 are formed on the electrically insulating layer 210, to form a first multilayer body 1001. For example, a substrate that has high electrical insulation properties and that can suppress eddy currents (such as a semiconductor substrate, a glass substrate, an organic resin substrate, and ceramic) is used as the substrate 1000. The electrically insulating layer 210 is formed, for example, by a step in which an organic resin is applied on the substrate 1000 and is cured. The first inductor wires 30 and the pad portions 81 are formed, for example, by seed formation (sputtered Ti/Cu), resist coating, development, exposure, electrolytic plating, resist stripping, and seed etching.

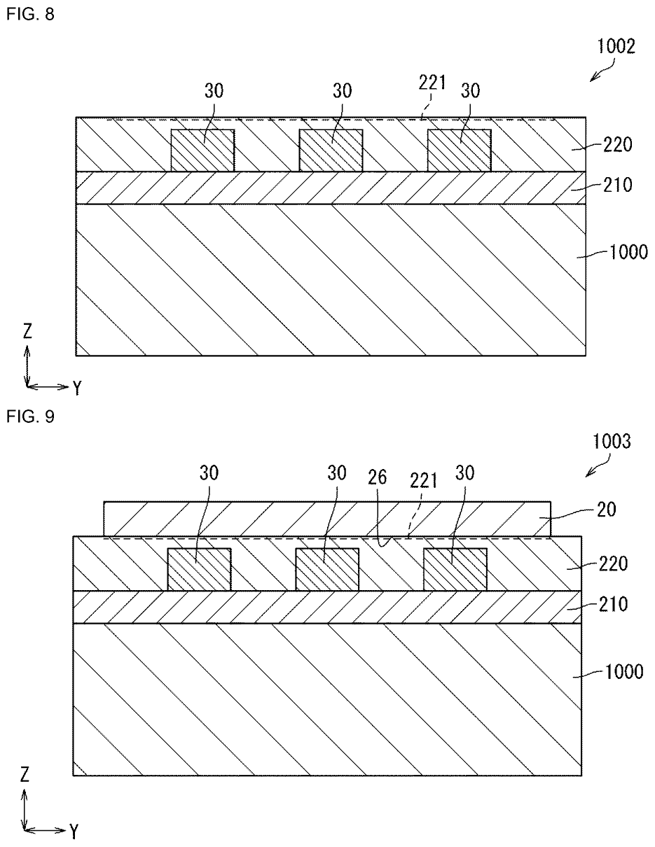

As shown in FIGS. 7 and 8, the electrically insulating layer 220 that covers the first inductor wires 30 and the pad portions 81 is formed on the electrically insulating layer 210 of the formed first multilayer body 1001, to form a second multilayer body 1002. The electrically insulating layer 220 is formed, for example, by a step in which an organic resin is applied on the electrically insulating layer 210 and cured. A surface 221 of the electrically insulating layer 220 is adjusted to a desired roughness by resist patterning and dry etching.

As shown in FIG. 9, the magnetic layer 20 is formed on the surface 221 of the electrically insulating layer 220 of the formed second multilayer body 1002, to form a third multilayer body 1003. A portion of the magnetic layer 20, facing the surface 221 of the electrically insulating layer 220, constitutes the planar portion 26. By adjusting the surface 221 of the electrically insulating layer 220 to a desired roughness through resist patterning and dry etching, the planar portion 26 of the magnetic layer 20, facing the surface 221, can be adjusted to have a similar roughness. As shown in FIG. 10, the magnetic layer 20 includes the plurality of inorganic electrically insulating layers 21 and the plurality of inorganic magnetic layers 22 that are alternately laminated along the first direction Z. The magnetic layer 20 is formed, for example, by a step in which sputtering of an insulating material and sputtering of a magnetic material are repeated. By forming the magnetic layer 20 using a sputtering method in a magnetic field, the atomic arrangement is formed at a desired position, and the direction of the applied magnetic field becomes the easy-axis direction. After the magnetic layer 20 is formed, the magnetic layer 20 can be formed at a desired position through resist coating, exposure, development, etching, and resist stripping.

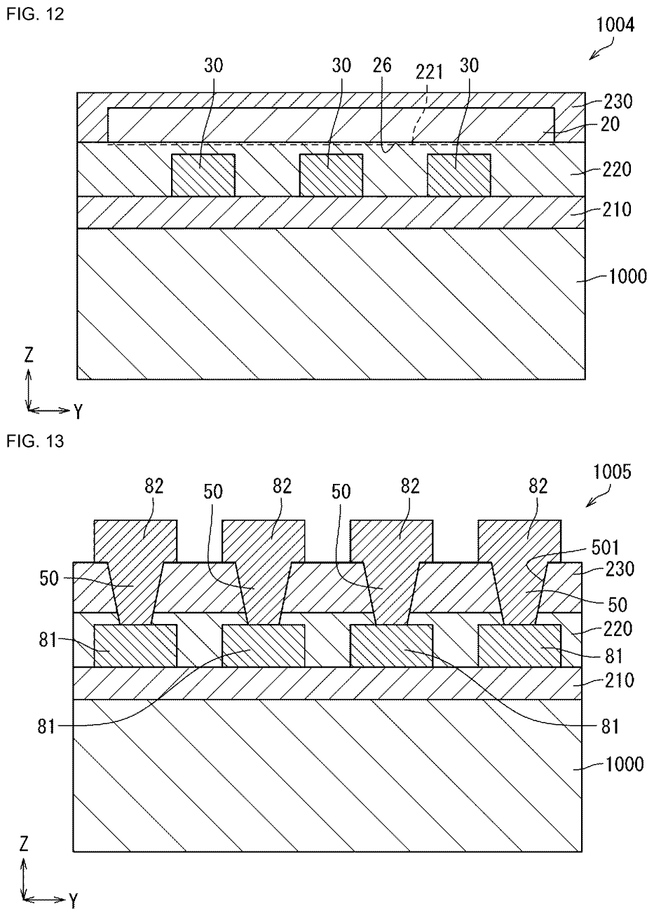

As shown in FIGS. 11 and 12, the electrically insulating layer 230 is formed on the electrically insulating layer 220 of the formed third multilayer body 1003, and via openings 501 are formed in the electrically insulating layer 230, to form a fourth multilayer body 1004. The electrically insulating layer 230 is formed, for example, by a step in which an organic resin is applied on the electrically insulating layer 220 and cured. The via openings 501 are, for example, formed using a laser so as to penetrate the electrically insulating layer 230 along the first direction Z to the electrically insulating layer 220 and to expose the pad portions 81 from the bottom surface.

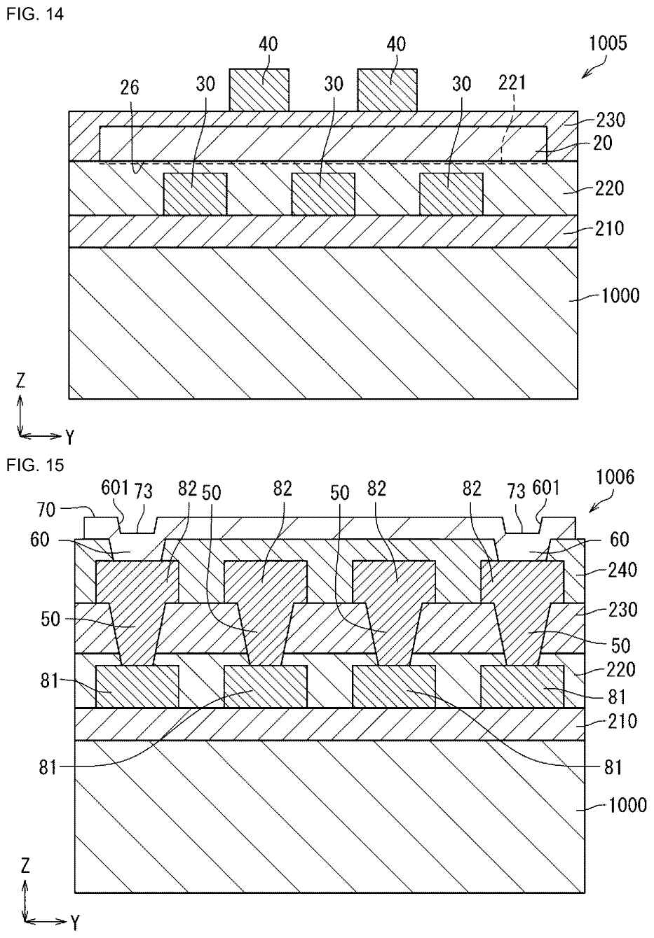

As shown in FIGS. 13 and 14, the first via portions 50 are formed in the via openings 501 of the formed fourth multilayer body 1004, the pad portions 82 are formed on the first via portions 50 and the electrically insulating layer 230, and the second inductor wires 40 are formed on the electrically insulating layer 230, to form a fifth multilayer body 1005. The second inductor wires 40 and the pad portions 82 are formed, for example, by seed formation (sputtered Ti/Cu), resist coating, development, exposure, electrolytic plating, resist stripping, and seed etching.

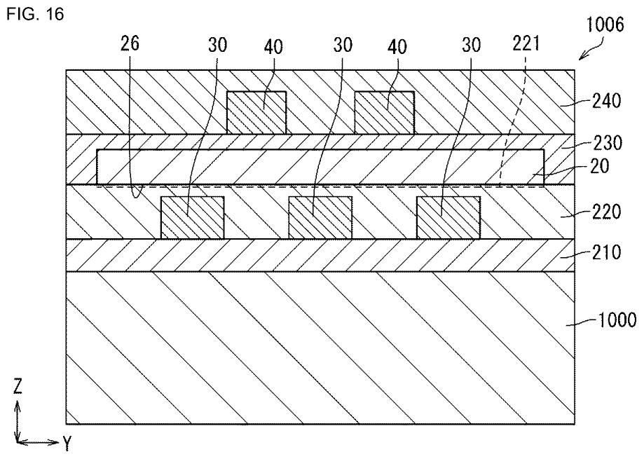

As shown in FIGS. 15 and 16, the electrically insulating layer 240 covering the second inductor wires 40 and the pad portions 82 is formed on the electrically insulating layer 230 of the formed fifth multilayer body 1005, via openings 601 are formed in the electrically insulating layer 240, and the external terminals 70 are formed, to form a sixth multilayer body 1006. The electrically insulating layer 240 is formed, for example, by a process in which an organic resin is applied on the electrically insulating layer 230 and cured. The via openings 601 are, for example, formed using a laser so as to extend along the first direction Z and to expose the pad portions 82 from the bottom surface. The external terminals 70 are formed, for example, by electroless Ni/Au plating. By performing Cu-filled plating first before the electroless Ni/Au plating, the external terminals 70 without the recessed portions 73 can be formed.

The inductor component 1 shown in FIGS. 2 and 3 is manufactured by removing the substrate 1000 from the formed sixth multilayer body 1006 and singulating the multilayer body. The substrate 1000 is removed, for example, by polishing or peeling. The inductor element 10 can exhibit the following advantageous effects.

The inductor element 10 includes the magnetic layer 20 provided along the first imaginary plane P1 and having uniaxial magnetic anisotropy, and inductor wires (in the present embodiment, the first inductor wires 30) spaced apart from the first imaginary plane P1 in a first direction that intersects the first imaginary plane P1 and provided along the second imaginary plane P2 parallel to the first imaginary plane P1. The roughness of the planar portion 26 of the magnetic layer 20 located on the first imaginary plane P1 is greater than or equal to 3 nm and less than or equal to 10 nm (i.e., from 3 nm to 10 nm). With this configuration, it is possible to improve the efficiency of obtaining inductance while ensuring the adhesion of the magnetic layer 20. For example, when the roughness of the planar portion 26 of the magnetic layer 20 is less than 3 nm, the contact area of the magnetic layer 20 reduces, with the result that the adhesion decreases. When the roughness of the planar portion 26 of the magnetic layer 20 is greater than 10 nm, the crystal structure of magnetic material included in the magnetic layer 20 becomes random, and the uniaxial magnetic anisotropy of the magnetic layer 20 collapses, so there is a possibility that the efficiency of obtaining inductance cannot be improved.

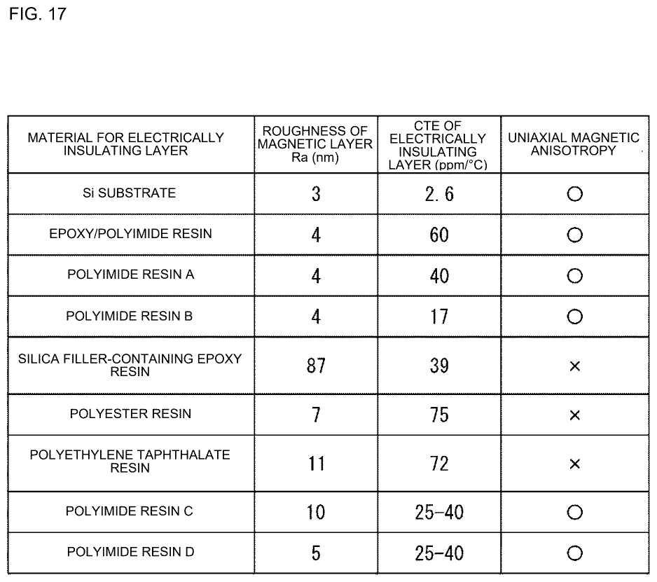

FIG. 17 shows the relationship between the roughness of the planar portion 26 of the magnetic layer 20 and the CTE of the electrically insulating layer 220 that is in direct contact with the planar portion 26. In FIG. 17, the case where the magnetic layer 20 has uniaxial magnetic anisotropy is indicated by “o”, and the case where the magnetic layer 20 does not have uniaxial magnetic anisotropy is indicated by “x”. As shown in FIG. 17, when the roughness Ra of the planar portion 26 satisfies “3 nm≤Roughness Ra≤10 nm”, the magnetic layer 20 is likely to have uniaxial magnetic anisotropy. When the CTE of the electrically insulating layer 220 that is in direct contact with the planar portion 26 satisfies “2 ppm/° C.≤CTE≤60 ppm/° C.”, the likelihood that the magnetic layer 20 has uniaxial magnetic anisotropy further increases. Furthermore, when the CTE of the electrically insulating layer 220 satisfies “2 ppm/° C.≤CTE≤35 ppm/° C.”, the magnetic layer 20 more reliably has uniaxial magnetic anisotropy. For example, it is assumed that the magnetic layer 20 is a multilayer body formed by sputtering (for example, the magnetic layer 20 that includes the inorganic electrically insulating layers 21 and the inorganic magnetic layers 22, shown in FIG. 10). When the CTE of the electrically insulating layer 220 is higher than 35 ppm/° C., strain occurs during a heat treatment that is applied when the magnetic layer 20 is formed, with the result that the crystal structure of the magnetic layer 20 becomes random. In this case, the uniaxial magnetic anisotropy of the magnetic layer 20 collapses, so there is a possibility that the efficiency of obtaining inductance cannot be improved. In other words, by configuring the inductor element 10 such that the CTE of the electrically insulating layer 220 is higher than or equal to 2 ppm/° C. and lower than or equal to 35 ppm/° C. (i.e., from 2 ppm/° C. to 35 ppm/° C.), the efficiency of obtaining inductance can be more reliably improved.

The inductor component 1 includes the inductor element 10 and the external terminals 70 electrically connected to the inductor wires. With this configuration, it is possible to realize the inductor component 1 that can be easily mounted on a circuit board.

The inductor wires are the first inductor wires 30 located on one side of the magnetic layer 20 in the first direction. The inductor element 10 includes the second inductor wires 40 and the first via portions 50. The second inductor wires 40 are located on the other side of the magnetic layer 20 in the first direction. Each of the first via portions 50 electrically connects the first inductor wire 30 and the second inductor wire 40. The first inductor wires 30, the second inductor wires 40, and the first via portions 50 constitute at least part of the inductor wound around the axis AX extending along a second direction that intersects the first direction. With this configuration, since the inductor is wound around the magnetic layer 20, the magnetic flux density passing through the magnetic layer 20 increases, so the high-quality factor inductor component 1 can be realized.

The absolute value of the angle θ formed between the hard axis or easy axis of the magnetic layer 20 and the axis AX is larger than or equal to zero degrees and smaller than 10 degrees (i.e., from zero degrees to smaller than 10 degrees). With this configuration, since most of the magnetic flux is oriented toward the anisotropy axis, the efficiency of obtaining inductance can be improved, and the direct-current superposition characteristics can be improved. Since the first inductor wires 30 extending along the imaginary plane P, the second inductor wires 40, and the first via portions 50 constitute part of the inductor, the inductor component 1 can be easily miniaturized (for example, reduced in thickness).

The inductor component 1 can be configured as follows.

The planar portion 26 of the magnetic layer 20 may have the same roughness over the entire surface. In this case, the patterning step is unnecessary, so the manufacturing cost of the inductor element 10 can be reduced. The “same roughness” includes roughness within a realistic variation range (for example, within an error of +10%).

Portions 31 (see FIG. 3) of the inductor wires (for example, the first inductor wires 30) located on the second imaginary plane P2 may have a roughness greater than the roughness of the planar portion 26 of the magnetic layer 20. With this configuration, the adhesion of the inductor wires can be enhanced. The roughness of the inductor wires is obtained similarly to the roughness of the planar portion 26.

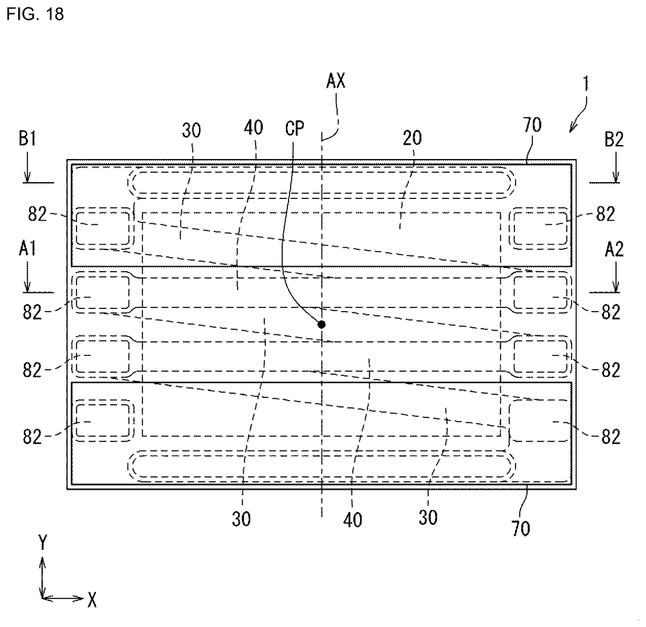

As shown in FIG. 18, the inductor component 1 may include the first via portion 50 that at least partially overlaps the magnetic layer 20 when viewed along the axis AX. In this case, since the magnetic flux can be blocked by the first via portions 50, noise leakage to the surroundings of the inductor component 1 can be suppressed.

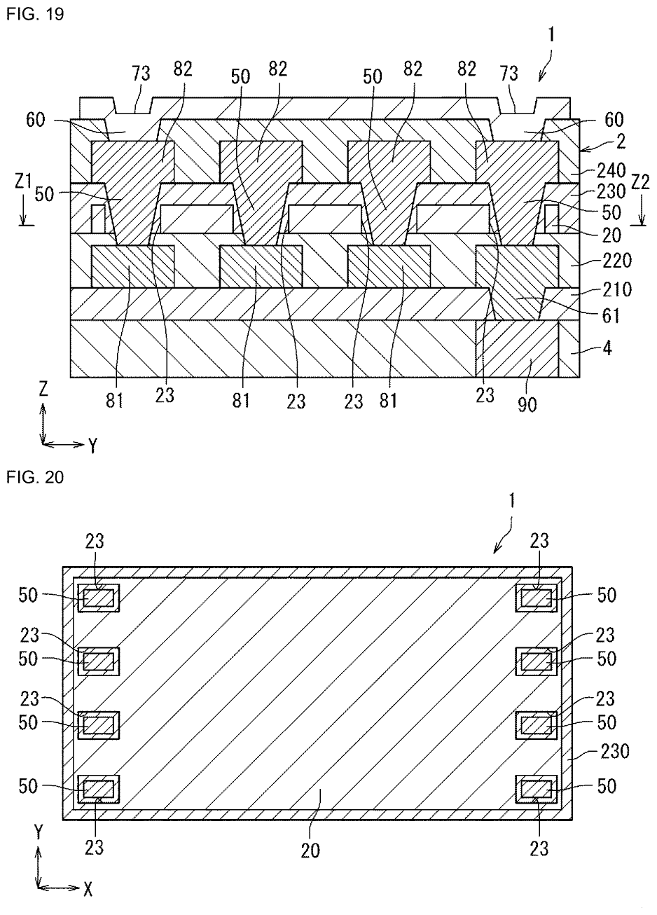

As shown in FIGS. 19 and 20, the inductor component 1 may include the first via portions 50 that penetrate the magnetic layer 20 along the first direction Z. In other words, the magnetic layer 20 can have through-holes 23 that can accommodate the first via portions 50. In this case, since the magnetic layer 20 can be maximized along the imaginary plane P, it is possible to suppress leakage flux while enhancing the efficiency of obtaining inductance with the inductor component 1. In the inductor component 1 shown in FIGS. 20 and 20, the magnetic layer 20 has the plurality of through-holes 23 corresponding to all the respective first via portions 50. Each of the through-holes 23 is configured to be able to accommodate the first via portion 50 in a state where a clearance is provided between the through-hole 23 and the first via portion 50. The shape of each of the through-holes 23 is not limited to a rectangular shape, and may also be a circular shape or another polygonal shape.

The inductor component 1 shown in FIGS. 19 and 20 is mounted on a substrate 4. In other words, the substrate 4 is connected to the inductor component 1 with the electrically insulating layer 210 interposed therebetween. Examples of the substrate 4 include a high-resistance silicon substrate, a glass substrate, and a ceramic substrate. A terminal 90 electrically connectable to an external circuit is formed within the substrate 4. The inductor component 1 shown in FIGS. 19 and 20 includes a vertical wire 61 that penetrates the electrically insulating layer 210 along the first direction Z and that connects one pad portion 81 and the terminal 90. In other words, the inductor component 1 shown in FIGS. 19 and 20 is configured to be electrically connectable to an external circuit with the vertical wire 61 and the terminal 90 interposed therebetween. The vertical wire 61 improves the flexibility of the mounting location for the inductor component 1.

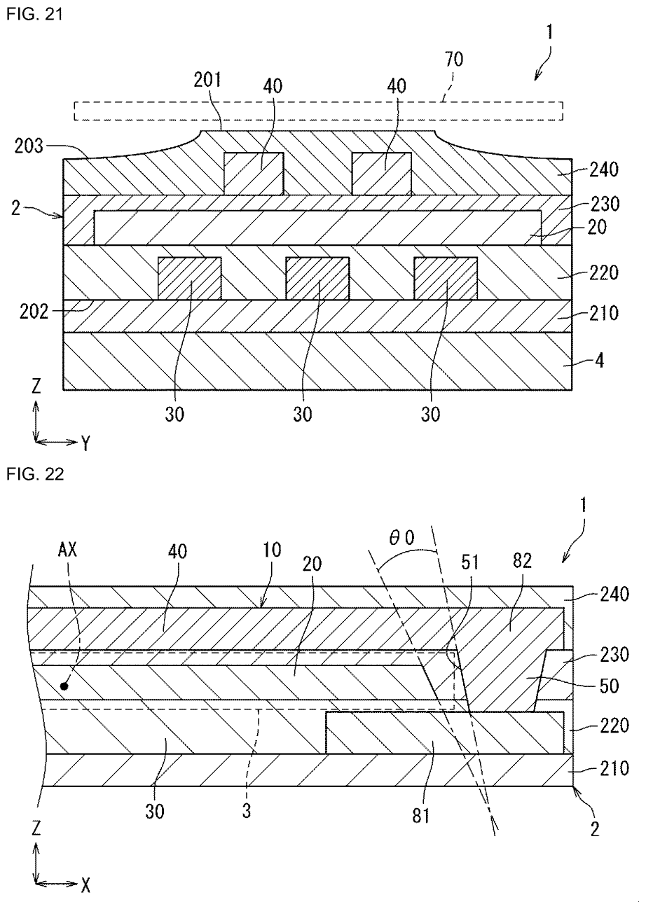

As shown in FIG. 21, the inductor component 1 may include the element body 2 in which the surface roughness of the first main surface 201 and the surface roughness of the second main surface 202 are different from each other. In this case, by performing resin molding on the main surface having a greater surface roughness, the adhesion to the molding material can be improved. In the inductor component 1 shown in FIG. 21, the external terminal 70 is located on the first main surface 201, and the element body 2 has recessed portions 203 that are recessed from the first main surface 201 toward the magnetic layer 20 in the first direction Z. In the inductor component 1 shown in FIG. 21, the element body 2 has two recessed portions 203. Alternatively, the element body 2 may have one recessed portion 203 or may have three or more recessed portions 203. As an example, the element body 2 is configured such that the first main surface 201 is positioned closer to the magnetic layer 20 than the external terminal 70. In the inductor component 1 shown in FIG. 21, since the external terminal 70 is located farthest from the magnetic layer 20, the inductor component 1 can be easily mounted on the substrate 4 or the like.

As shown in FIG. 22, the inductor component 1 may be configured such that the magnetic layer 20 has a first end portion 25 that faces the first via portion 50 in the third direction X, the first via portion 50 has a second end portion 51 that faces the magnetic layer 20 in the third direction X, and the first end portion 25 and the second end portion 51 are inclined in the same direction relative to the first direction Z. With this configuration, the first end portion 25 of the magnetic layer 20 and the second end portion 51 of the first via portion 50 can be brought close to each other, so the inductor can be miniaturized. By bringing the first end portion 25 of the magnetic layer 20 and the second end portion 51 of the first via portion 50 close to each other, the volume of the magnetic layer 20 can be increased, so the efficiency of obtaining inductance can be improved. The phrase “inclined in the same direction” means that, for example, when viewed in a cross section including the first direction Z and the third direction X, the angle θ0 formed between the extension of the first end portion 25 and the extension of the second end portion 51 is in the range larger than or equal to zero degrees and smaller than 45 degrees (i.e., from zero degrees to smaller than 45 degrees). As shown in FIG. 21, a portion surrounded by the first inductor wire 30, the second inductor wire 40, and the first via portion 50 constitutes a core portion 3.

The magnetic layer 20 may have only one inclined end in the third direction X, or may have both inclined ends in the third direction X. It is assumed that opposite ends of the magnetic layer 20 in the third direction X are inclined (that is, the magnetic layer 20 has the first end portions 25 respectively at opposite ends in the third direction X). It is also assumed that the first inductor wire 30 and the second inductor wire 40 are laminated in this order. In this case, when viewed in a cross section including the first direction Z and the third direction X, the magnetic layer 20 has a trapezoidal shape in which one of opposite ends in the first direction Z closer to the first inductor wire 30 is the long side and the other end closer to the second inductor wire 40 is the short side, and the first via portion 50 has a trapezoidal shape in which the positions of the long side and short side are reversed as compared with the magnetic layer 20 (in other words, an inverted trapezoidal shape). When the first via portion 50 has an inverted trapezoidal shape relative to the magnetic layer 20, the seed adhesion improves. In this case, since the magnetic layer 20 has a trapezoidal shape, the distance between the magnetic layer 20 and the first via portion 50 is more easily maintained, so electrical insulation properties can be more easily ensured. The order in which the first inductor wire 30 and the second inductor wire 40 are laminated can be determined based on a direction in which a seed is present, the shapes of the first inductor wire 30 and the second inductor wire 40, or the like.

When the second end portion 51 of the first via portion 50 has a smaller inclination angle than the first end portion 25 of the magnetic layer 20, the first via portion 50 can be reduced in size, so the volume of the magnetic layer 20 can be increased. When the second end portion 51 of the first via portion 50 has a larger inclination angle than the first end portion 25 of the magnetic layer 20 and the first via portion 50 has an inverted trapezoidal shape, the seed adhesion can be improved. When the second end portion 51 of the first via portion 50 has a larger inclination angle than the first end portion 25 of the magnetic layer 20 and the first via portion 50 has a trapezoidal shape, the first via portion 50 serves as an anchor, so the adhesion strength between the first via portion 50 and the first inductor wire 30 can be enhanced. As an example, an angle relative to an imaginary straight line extending in the first direction Z is referred to as an inclination angle.

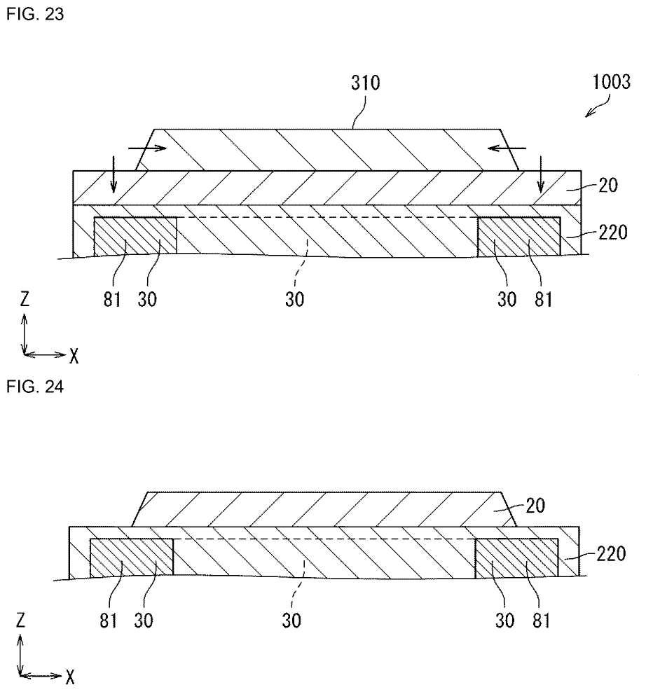

An example of a method of forming the trapezoidal magnetic layer 20 having the first end portions 25 at opposite ends in the third direction X (an example of a method of forming the inductor component 1 shown in FIG. 22) will be described with reference to FIGS. 23 and 24.

As shown in FIG. 23, a resist 310 having a tapered shape is formed on the magnetic layer 20 of the third multilayer body 1003. A tapered shape refers to a shape that tapers from the first inductor wire 30 toward the second inductor wire 40 along the first direction Z. When the resist 310 and the magnetic layer 20 are etched by dry etching, the resist 310 recedes while the magnetic layer 20 is etched in the direction indicated by the arrows in FIG. 23, with the result that the trapezoidal magnetic layer 20 shown in FIG. 24 is formed.

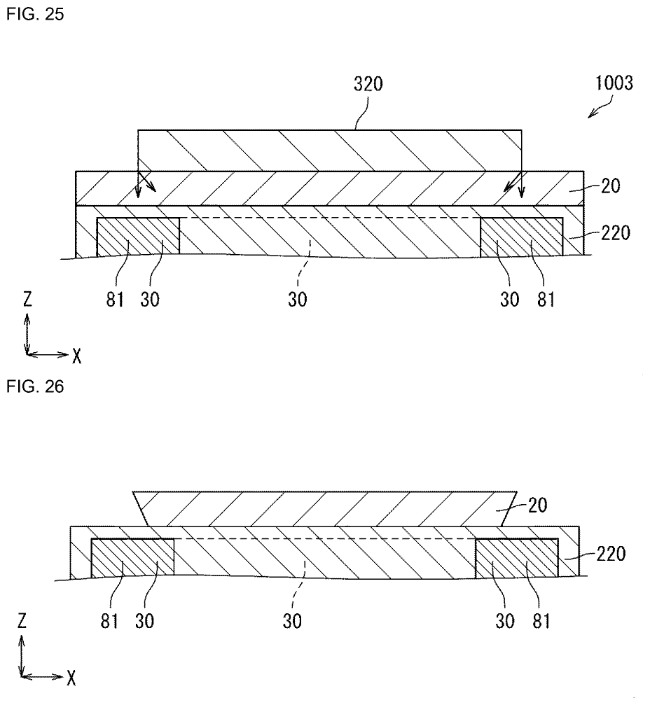

An example of a method of forming the inverted trapezoidal magnetic layer 20 having the first end portions 25 at opposite ends in the third direction X (an example of a method of forming the inductor component 1 in which the directions in which the first end portions 25 of the magnetic layer 20 are inclined are reversed from the directions in FIG. 22) will be described with reference to FIGS. 25 and 26. In this case, the first end portion 25 is inclined away from the first via portion 50 as the first end portion 25 extends from the second inductor wire 40 toward the first inductor wire 30 along the first direction Z.

As shown in FIG. 25, a resist 320 having a substantially rectangular cross-sectional shape is formed on the magnetic layer 20 of the third multilayer body 1003. When the resist 320 and the magnetic layer 20 are etched by wet etching, the magnetic layer 20 is etched in an oblique direction (indicated by arrows in FIG. 25) from portions where liquid replacement easily occurs, with the result that the inverted trapezoidal magnetic layer 20 shown in FIG. 26 is formed.

It is sufficient that the inductor component 1 includes at least one inductor element 10.

The inductor component 1 is not limited to the case where the inductor component 1 includes the external terminals 70 located on the first main surface 201 of the element body 2. Alternatively, the inductor component 1 may include the external terminals 70 located on the second main surface 202 of the element body 2, or may include the external terminals 70 located on both the first main surface 201 and the second main surface 202 of the element body 2.

The magnetic layer 20 is not limited to the case where the magnetic layer 20 includes the inorganic electrically insulating layers 21 and the inorganic magnetic layers 22 laminated along the first direction. For example, the magnetic layer 20 may be composed of a composite material of resin and magnetic filler. In this case, examples of the resin include epoxy, polyimide, acrylic, phenolic, and combinations of these materials. Examples of the magnetic filler include FeSiCr-based, FeNi-based, FeSi-based, pure Fe, and combinations of these materials.

### Second Embodiment

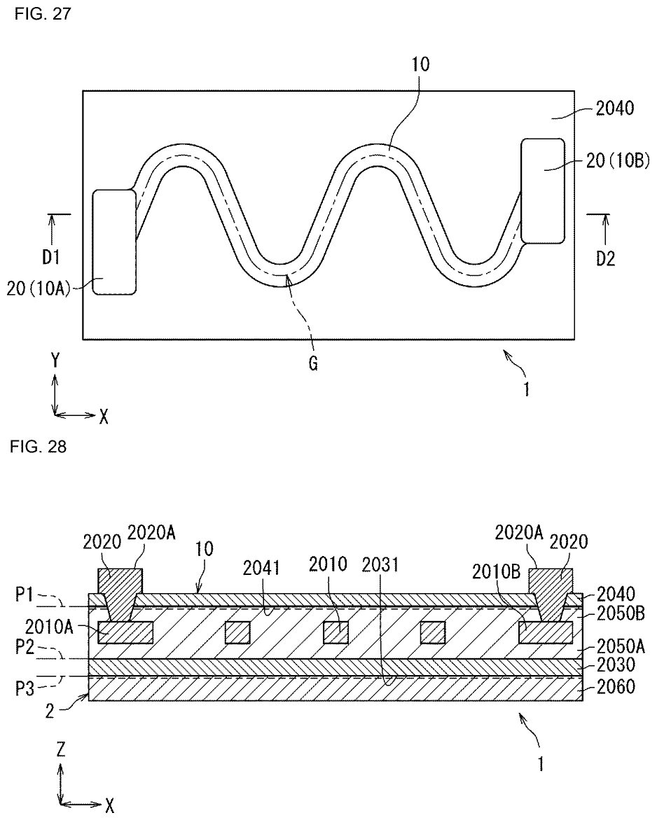

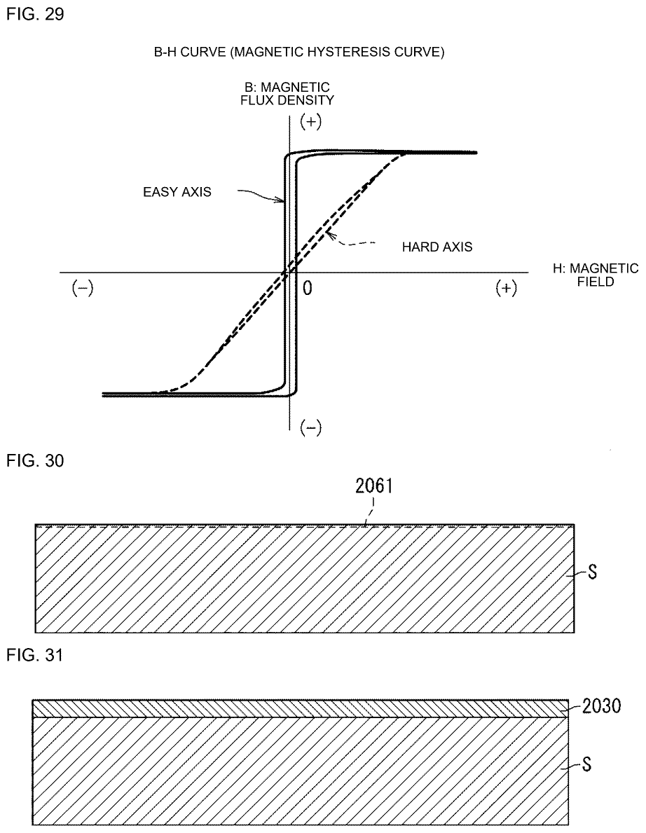

Next, the inductor component 1 including the inductor element 10 according to a second embodiment of the present disclosure will be described with reference to FIGS. 27 to 51. FIGS. 27 to 51 generally show a state where the inductor component having a substantially rectangular parallelepiped outer shape is placed on a horizontal plane with the substrate side facing downward, and with the long-side direction represented as an X-axis, the short-side direction represented as a Y-axis, and the height direction orthogonal to those directions represented as a Z-axis.

In the inductor component 1, a first magnetic layer 2030 is formed on a substrate 2060, a first electrically insulating layer 2050A is formed on the first magnetic layer 2030, an inductor wire 2010 and a second electrically insulating layer 2050B covering the inductor wire 2010 are formed on the first electrically insulating layer 2050A, and a second magnetic layer 2040 is further formed on the second electrically insulating layer 2050B. The inductor wire 2010 extends along the plane and includes pad portions 2010A and 2010B at opposite ends. Vertical wires 2020 are formed so as to extend from the pad portions 2010A and 2010B respectively at opposite ends perpendicularly to the plane along which the inductor wire 2010 extends. In the inductor component 1, the inductor wire 2010 is disposed between the first magnetic layer 2030 and the second magnetic layer 2040 in the Z-axis direction. In other words, the inductor component 1 includes the inductor element 10, the pad portions 2010A and 2010B, and the vertical wires 2020. With the vertical wires 2020, portions extended from the side surfaces of the inductor component 1 to external terminals are no longer needed, so the footprint of the inductor component 1 can be reduced. As a result, the inductor component 1 can be miniaturized. The inductor element 10 includes the element body 2, the first magnetic layer 2030, the second magnetic layer 2040, and the inductor wire 2010 that are located within the element body 2, and the substrate 2060. The second magnetic layer 2040 is provided along the first imaginary plane P1, the inductor wire 2010 is provided along the second imaginary plane P2, and the first magnetic layer 2030 is provided along the third imaginary plane P3. The third imaginary plane P3 is parallel to the first imaginary plane P1 and the second imaginary plane P2, and the second imaginary plane P2 is located between the first imaginary plane P1 and the third imaginary plane P3 in the first direction (for example, the Z direction). In other words, the inductor wire 2010 is located between the first magnetic layer 2030 and the second magnetic layer 2040 in the first direction Z. With this configuration, it is possible to reduce leakage flux and improve the efficiency of obtaining inductance. The term “parallel” includes “substantially parallel”. As an example, the roughness of a planar portion 2031 of the first magnetic layer 2030 and the roughness of a planar portion 2041 of the second magnetic layer 2040 are different from each other. With this configuration, the flexibility in selecting a material for the first magnetic layer 2030 and the second magnetic layer 2040 can be improved. As a result, for example, the strength and adhesion of the element body 2 can be improved.

In the present embodiment, a high-resistance silicon substrate is adopted as the substrate 2060. However, the configuration is not limited thereto, and another selected inorganic substrate (inorganic material substrate), such as a glass substrate and a ceramic substrate, may be adopted as the substrate 2060. For example, when the element body 2 includes an inorganic material substrate, such as an Si substrate, a glass substrate, and a ceramic substrate, harder than an organic resin, the strength of the element body 2 can be improved. In the inductor component 1, for example, a substrate having high electrical insulation properties is adopted in terms of suppressing occurrence of eddy currents. The thickness of the substrate 2060 may be, for example, 5 μm; however, the thickness is not limited thereto. In the present embodiment, since the layers including the first magnetic layer 2030 and constituting the inductor component 1 are formed on an inorganic substrate, chip strength can be ensured even when the layers are thin. The substrate 2060 has a roughness less than the roughness of the planar portion 2031 of the first magnetic layer 2030 and the roughness of the planar portion 2041 of the second magnetic layer 2040. With this configuration, the roughness of each of the first electrically insulating layer 2050A and the second electrically insulating layer 2050B of the element body 2 can be easily adjusted.

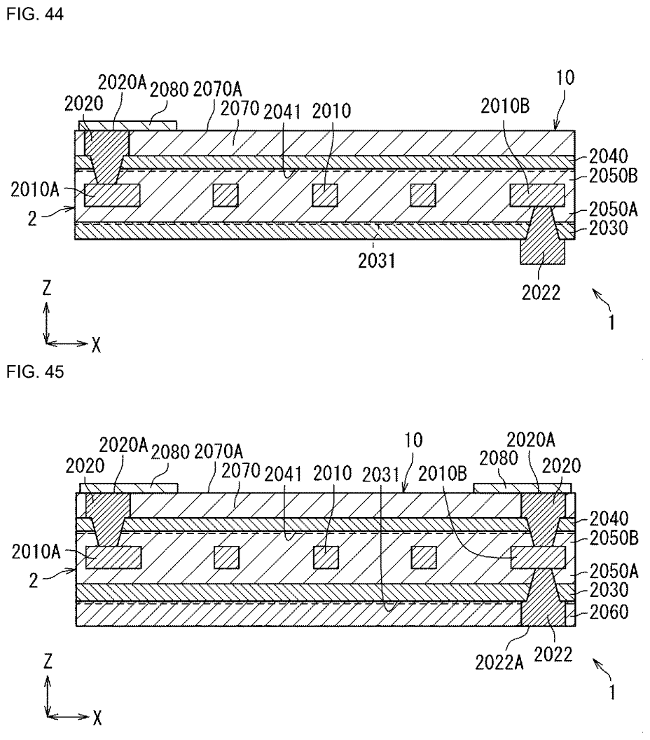

As described later with reference to FIG. 44, the inductor component 1 that does not include the substrate 2060 may be adopted. An organic electrically insulating layer can be formed between the substrate 2060 and the first magnetic layer 2030.

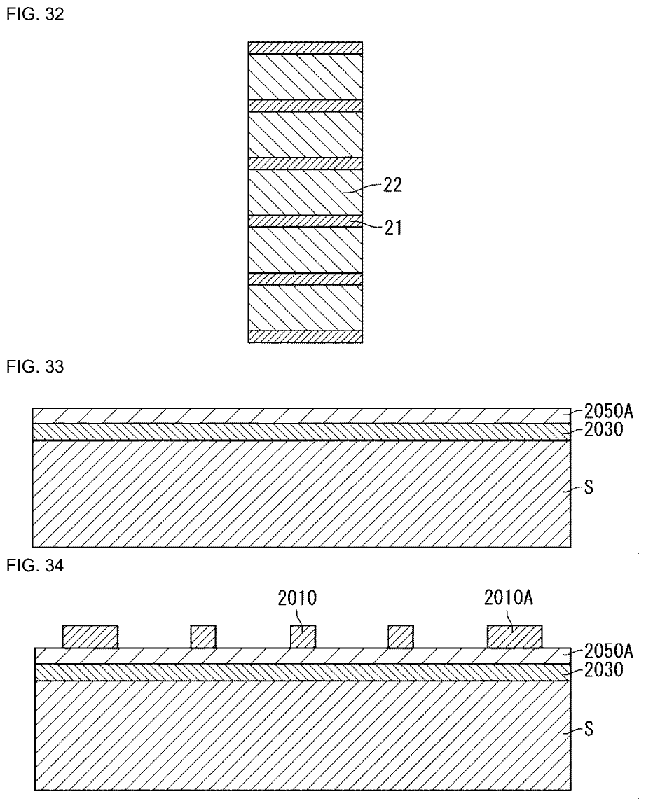

Each of the first magnetic layer 2030 and the second magnetic layer 2040 includes a multilayer body composed of the inorganic electrically insulating layers 21 and the inorganic magnetic layers 22 (see FIG. 32). The thickness of each of the first magnetic layer 2030 and the second magnetic layer 2040 may be, for example, in the range of about 5 μm to about 6 μm; however, the thickness is not limited thereto. The materials and detailed structure of the first magnetic layer 2030 and the second magnetic layer 2040 will be described in detail later in the description of the manufacturing method.

In the present embodiment, the first electrically insulating layer 2050A and the second electrically insulating layer 2050B are formed of polyimide. However, the configuration is not limited thereto. Other organic resins, such as epoxy and phenolic, or combinations of these materials may also be used, and may include an electrical insulation filler. Furthermore, the first electrically insulating layer 2050A and the second electrically insulating layer 2050B may also be formed of an inorganic electrical insulator, such as SiO₂ and TaO. In the present embodiment, the thickness of the first electrically insulating layer 2050A may be 5 μm; however, the thickness is not limited thereto. The thickness of the second electrically insulating layer 2050B is a value obtained by adding about 2 μm to about 10 μm to the thickness of the inductor wire 10.

The inductor wire 2010 including the pad portions 2010A and 2010B at opposite ends and the vertical wires 2020 are formed of an electrically conductive material having low electrical resistance, such as copper, silver, and gold. Preferably, a conductor including copper or copper compounds is used. The vertical wires 2020 are electrically connected to the inductor wire 2010 with the pad portions 2010A and 2010B at opposite ends interposed therebetween. In the present embodiment, a flat wire having a cross-sectional dimension of 40 μm×20 μm is used as the inductor wire 2010; however, the configuration is not limited thereto. There can be cases where flat wires having different dimensions are used or a wire other than a flat wire can be used.

The vertical length of each of the vertical wires 2020 is determined by the thickness of each of the second electrically insulating layer 2050B and the second magnetic layer 2040, and the amount of protrusion from the surface of the second magnetic layer 2040. In the present embodiment, the amount of protrusion of the vertical wire 2020 from the surface of the second magnetic layer 2040 is 5 μm; however, the amount of protrusion is not limited thereto.

The inductor component 1 configured as described above generally has a substantially rectangular parallelepiped outer shape, and, where the length in the long-side direction (X-axis direction) is L, the length in the short-side direction (Y-axis direction) is W, and the length in the height direction (Z-axis direction) is T, the inductor component 1 has dimensions of L×W×T=1.0 mm×0.5 mm×0.5 mm. However, this is merely an example, and an inductor component having any other outer dimensions may be adopted.

By electrically connecting the vertical wires 2020, which protrude from the surface of the second magnetic layer 2040, to an external circuit, current can be passed through the inductor wire 2010 via the vertical wires 2020 to generate magnetic flux, so the inductor component 1 can be caused to function as an inductor.

As shown in FIG. 27, the vertical wires 2020 are formed such that the cross-sectional area increases from the end surfaces that are in contact with the pad portions 2010A and 2010B toward end surfaces 2020A on the opposite side. As a result, the connection strength with an external circuit or an external terminal is improved at the end surface 2020A, so the connection electrical resistance can be suppressed.

In the present embodiment, as shown in FIG. 27, the vertical wires 2020 penetrate the second magnetic layer 2040. In this way, in the plan view, the second magnetic layer 2040 is formed so as to cover the entire circumference of the vertical wires 2020, and the region of the second magnetic layer 2040 is maximally extended in the plane direction. As a result, the efficiency of obtaining inductor can be improved, and leakage flux can be suppressed.

In the inductor component 1, a plurality of electrically conductive layers is formed on the end surface 2020A of each of the vertical wires 2020. For example, electrochemical migration resistance can be imparted by forming a Ni layer as an electrically conductive layer on the end surface 2020A, and, furthermore, solder wettability can be imparted by forming an Au layer, an Sn layer, or the like, as an electrically conductive layer. As a result, an appropriate function can be imparted for connection to an external circuit.

In the inductor component 1, the pad portions 2010A and 2010B are disposed in the regions at opposite ends in the long-side direction (X-axis direction). The inductor wire 2010 extends in the long-side direction from one pad portion 2010A (2010B) while meandering to form a smooth curve to reach the other pad portion 2010B (2010A). Thus, a so-called meander inductor is formed.

The first magnetic layer 2030 and the second magnetic layer 2040, disposed above and below the inductor wire 2010, have uniaxial magnetic anisotropy in the same axial direction. In the present embodiment, the two anisotropy axes (easy axis and hard axis) of each of the first magnetic layer 2030 and the second magnetic layer 2040 are parallel to the long-side direction (X-axis direction) and the short-side direction (Y-axis direction) when the inductor component 1 is viewed in plan view (see FIG. 26). The fact that “the first magnetic layer 2030 and the second magnetic layer 2040 have uniaxial magnetic anisotropy in the same axial direction” means that, in consideration of variations in manufacturing, the angle formed between the anisotropy axes of the first magnetic layer 2030 and the second magnetic layer 2040 is smaller than 10 degrees.

The anisotropy axes of each of the first magnetic layer 2030 and the second magnetic layer 2040, which have uniaxial magnetic anisotropy in the same axial direction, will be described in more detail. As an example, the easy-axis direction and hard-axis direction of uniaxial magnetic anisotropy can be determined by rotating a sample by 90 degrees and measuring the magnetic layer with a vibrating sample magnetometer (VSM) to obtain a B-H curve. The B-H curve is also referred to as a magnetic hysteresis curve. An example of the measured B-H curve is shown in FIG. 28. In the graph shown in FIG. 28, the vertical axis represents the magnetic flux density B (unit: T), and the horizontal axis represents the magnetic field strength H (unit: A/m).

When the magnetic permeability is denoted by u, the relationship B=μH holds. In other words, the slope of the B-H curve shown in FIG. 28 represents the magnetic permeability μ. The steeply rising B-H curve represents the easy axis (magnetization easy axis), and the gently sloping B-H curve represents the hard axis (magnetization hard axis). When the direction of the magnetic flux generated by flowing current through the inductor wire 2010 is parallel to the easy axis, the efficiency of obtaining inductor can be improved. On the other hand, when the direction of the magnetic flux generated by flowing current through the inductor wire 2010 is parallel to the hard axis, the direct-current superposition characteristics can be improved or iron loss can be reduced. As a sample for testing the uniaxial magnetic anisotropy, the sample preferably has a circular or square planar shape to eliminate the influence of shape anisotropy; however, measurement can also be performed with other shapes.

In the present embodiment, both a case in which the hard axes of the first magnetic layer 2030 and the second magnetic layer 2040 having uniaxial magnetic anisotropy are oriented in the long-side direction (X-axis direction) and the easy axes are oriented in the short-side direction (Y-axis direction), and a case in which the easy axes are oriented in the long-side direction (X-axis direction) and the hard axes are oriented in the short-side direction (Y-axis direction), are possible.

Opposite ends of the inductor wire 2010 are disposed apart in one anisotropy-axis direction (X-axis direction) of the hard-axis direction and the easy-axis direction in uniaxial magnetic anisotropy. The positions of opposite ends of the inductor wire 10 in the other anisotropy-axis direction (Y-axis direction) can be the same position or can be different positions. The inductor wire 2010 extends in a meandering manner in one anisotropy-axis direction (X-axis direction) between the pad portions 2010A and 2010B at opposite ends. It should be noted that the inductor wire 2010 extends throughout the entire region without being orthogonal to one anisotropy axis (X-axis direction). In other words, the inductor wire 2010 extending between the pad portions 2010A and 2010B at opposite ends constantly has a vector component in one anisotropy-axis direction (X-axis direction). The inductor wire 2010 does not have only a vector component in the other anisotropy-axis direction (Y-axis direction) without having a vector component in one anisotropy-axis direction (X-axis direction).

It can also be described that a wire center line G (see FIG. 26) passing through the center of the inductor wire 2010 in the width direction extends without being orthogonal to one anisotropy axis (X-axis direction) throughout the entire region. It can also be described that the angle at which the wire center line G intersects one anisotropy axis (X-axis direction) is smaller than 90 degrees.

Within the inductor wire extending along the plane, there is a spiral wire, and, when one turn is defined as a 360-degree rotation of the inductor wire in the spiral wire, it can be described that in the present embodiment, the inductor wires 2010 each corresponding to less than 0.5 turns are connected.

When the inductor wire 2010 extends in one anisotropy-axis direction (for example, the X-axis direction), the inductor wire 2010 has a vector component in one anisotropy-axis direction (for example, the X-axis direction), so most of the magnetic flux can be directed toward the other anisotropy-axis direction (for example, the Y-axis direction). If the inductor wire 2010 has a region that extends perpendicularly in one anisotropy-axis direction (for example, the X-axis direction), all the magnetic flux is directed toward one anisotropy-axis direction (for example, the X-axis direction) in that region, so the influence is exerted in that region.

In the present embodiment, since the inductor wire 2010 extends in one anisotropy-axis direction (for example, the X-axis direction), most of the magnetic flux can be directed toward the other anisotropy-axis direction (for example, the Y-axis direction). As a result, the effect of directing the magnetic flux in the other anisotropy-axis direction (for example, the Y-axis direction) is obtained. Along with this, since the inductor wire 2010 extends without being orthogonal to one anisotropy axis (for example, the X-axis) throughout the entire region, the influence of one anisotropy axis (for example, the X-axis) can be suppressed. As a result, effects like improvement in the efficiency of obtaining inductance, improvement in direct-current superposition characteristics, and suppression of iron loss are reliably obtained. Furthermore, since the inductor component 1 is connected to an external circuit with the vertical wires 2020 interposed therebetween, the inductor component 1 can be efficiently mounted.

When one anisotropy axis oriented in the long-side direction (for example, the X-axis direction) is the hard axis, most of the magnetic flux passes through the easy axis (for example, the Y-axis direction), so the efficiency of obtaining inductance can be improved. On the other hand, when one anisotropy axis oriented in the long-side direction (for example, the X-axis direction) is the easy axis, most of the magnetic flux passes through the hard axis (for example, the Y-axis direction), so the direct-current superposition characteristics can be improved or iron loss can be reduced.

When the inductor component 1 has a substantially rectangular parallelepiped outer shape as described above and the easy axis is oriented in the long-side direction of the rectangular parallelepiped, the inductor component 1 further has the following advantages. Considering the influence of shape magnetic anisotropy, it is easier to control the anisotropy axis when the long-side direction is set as the easy axis. Furthermore, opposite ends of the inductor wire 10 are spaced apart in the easy-axis direction, and the pad portions 10A and 10B at opposite ends are disposed so as to at least partially overlap each other when viewed in the easy-axis direction. As a result, since the inductor wire extends without being orthogonal to the easy axis throughout the entire region, most of the magnetic flux passes through the hard axis, so improvement in the direct-current superposition characteristics and suppression of iron loss can be achieved.

An example of a manufacturing method for the inductor component 1 according to the second embodiment will be described with reference to FIGS. 30 to 41.

As shown in FIG. 30, step 1 of preparing a substrate material S is performed. The substrate material S is formed of a high-resistance silicon as described above. The thickness of the illustrated substrate material S is greater than the final thickness of the substrate 2060. A step of forming a plurality of inductor components on the single substrate material S and then singulating the substrate material S to obtain individual inductor components 1 is performed. The roughness of a surface 2061 of the substrate 2060 is adjusted by CMP, grinding, and roughening treatment.

As shown in FIG. 31, step 2 of laminating the first magnetic layer 2030 on the substrate material S is performed. As shown in the enlarged view on the right side of FIG. 32, the first magnetic layer 2030 includes a multilayer body composed of the inorganic electrically insulating layers 21 and the inorganic magnetic layers 22. The first magnetic layer 2030 is formed by, for example, sequentially laminating the inorganic electrically insulating layers 21 and the inorganic magnetic layers 22 through sputtering. The inorganic electrically insulating layers 21 may also be referred to as sputtered electrically insulating layers, and the inorganic magnetic layers 22 may also be referred to as sputtered magnetic layers.

The following method can be illustrated as a method of imparting uniaxial magnetic anisotropy to the first magnetic layer 2030. When the inorganic magnetic layer 22 is formed by sputtering in a magnetic field, the atomic arrangement within the inorganic magnetic layer 22 is formed at a desired position, and the easy-axis direction can be oriented in the direction of the applied magnetic field. When the direction of the applied magnetic field is oriented in the long-side direction of the inductor component 1, the easy axis is oriented in the long-side direction; whereas, when the direction of the applied magnetic field is oriented in the short-side direction of the inductor component 1, the hard axis is oriented in the long-side direction.

The inorganic electrically insulating layer 21 may be formed of an inorganic electrical insulator, such as SiO₂ and TaO. The inorganic magnetic layer 22 may be formed of Co—Zr—Ta (CZT), a FeNi alloy, or a composite of a magnetic material and an inorganic material. The interlayer thickness between the inorganic magnetic layers 22 may be thinner than each inorganic magnetic layer 22. Since the function of the inorganic electrically insulating layers 21 is to insulate between the inorganic magnetic layers 22 or to protect the inorganic magnetic layers 22 from stress during processing, the proportion of the magnetic layer in the overall multilayer body can be increased as the thickness reduces. By using a multilayer structure in which the inorganic electrically insulating layers 21, such as TaO and SiO₂, are disposed between the inorganic electrically insulating layers 21, the inorganic magnetic layers 22 are insulated from each other, and eddy currents in the inorganic magnetic layers 22 can be suppressed, so the inductor component 1 having a high quality factor at radio frequencies can be realized.

When the inorganic magnetic layer 22, such as Co—Zr—Ta (CZT) and a FeNi alloy, is made thick, eddy currents are generated within the magnetic layer. Therefore, in the embodiment, the inorganic magnetic layer 22 is configured to be thinner than the skin depth derived from the circuit operating frequency, for example, the switching frequency of a DC-DC converter. Since the inductor is a current element, the inductor wire 2010 is configured to have a predetermined thickness so that a large current can flow.

As an example, the inductor component 1 is configured such that the total thickness of the laminated inorganic magnetic layers 22 is smaller than the thickness of the inductor wire 2010. When the inorganic magnetic layer 22 is thin, eddy currents within the inorganic magnetic layer 22 can be suppressed. When the thickness of the inductor wire 2010 is increased, the inductor component 1 having a low direct-current resistance and a high efficiency of obtaining inductor can be realized.

In the present embodiment, the inorganic electrically insulating layers 21 are located at the surfaces of the first magnetic layer 2030. Thus, since the inorganic electrically insulating layers 21 are located at the surfaces of the first magnetic layer 2030, the first magnetic layer 2030 can be reliably insulated from peripheral members, such as wires. The same applies to the second magnetic layer 2040 (described later).

As shown in FIG. 33, step 3 of laminating the first electrically insulating layer 2050A on the first magnetic layer 2030 formed in step 2 is performed. Specifically, by applying polyimide, which is an organic resin, to the first magnetic layer 2030 and curing the polyimide, the first electrically insulating layer 2050A can be formed.

As shown in FIG. 34, step 4 of forming the inductor wire 2010 on the first electrically insulating layer 2050A formed in step 3 using electrolytic plating is performed. Specifically, a seed layer including Ti/Cu is formed on the first electrically insulating layer 2050A using a sputtering method. Then, a dry film resist (DFR) is laminated on the seed layer, and a seed layer having a shape corresponding to the inductor wire is exposed by photolithography. Then, electric power is supplied from the seed layer, and a plating portion is deposited on the exposed seed layer by electrolytic plating, to form the inductor wire. Then, by stripping the dry film resist (DFR) and etching the seed layer, an electrically insulated independent inductor wire is obtained. Thus, the inductor wire 2010 having a meandering shape is formed.

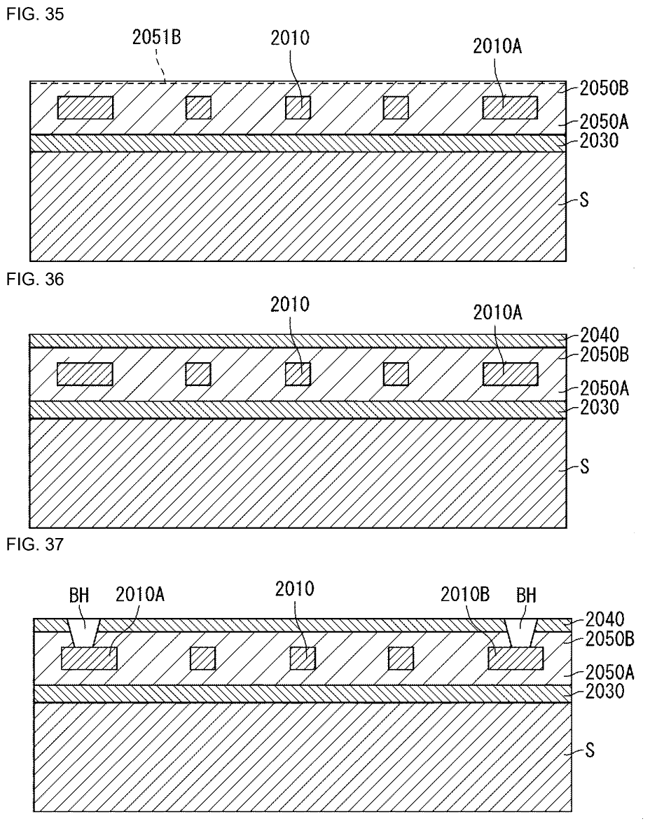

As shown in FIG. 35, step 5 of laminating the second electrically insulating layer 2050B on the first electrically insulating layer 2050A on which the inductor wire 2010 formed in step 4 is disposed is performed. Specifically, the second electrically insulating layer 2050B can be formed by applying polyimide, which is an organic resin, and curing the polyimide, in the same manner as for the first electrically insulating layer 2050A. As a result, the second electrically insulating layer 2050B is formed so as to cover a side surface and an upper surface of the inductor wire 2010. In this way, the first electrically insulating layer 2050A and the second electrically insulating layer 2050B surrounding the inductor wire 2010 are formed. The surface roughness of a surface 2051B of the second electrically insulating layer 2050B is adjusted by CMP, grinding, and roughening treatment.

As shown in FIG. 36, step 6 of laminating the second magnetic layer 2040 on the second electrically insulating layer 2050B formed in step 5 is performed. The second magnetic layer 2040 can also be laminated in a similar step to the first magnetic layer 2030, and the easy-axis direction of the inorganic magnetic layer can be oriented in the direction of the applied magnetic field by a sputtering method in a magnetic field as in the case of the first magnetic layer 2030. By applying the magnetic field in the same direction at the time of forming the first magnetic layer 2030 and the second magnetic layer 2040, the first magnetic layer 2030 and the second magnetic layer 2040 can have uniaxial magnetic anisotropy in the same axial direction.

As shown in FIG. 37, step 7 of forming via holes from the surface side of the second magnetic layer 2040 formed in step 6 is performed. Specifically, laser light is irradiated from the surface side of the second magnetic layer to remove part of the second magnetic layer 2040 and the second electrically insulating layer 2050B, to form via holes BH that reach the pad portions 2010A and 2010B of the inductor wire 2010. Each of the formed via holes BH has a shape that narrows from the surface side of the second magnetic layer toward the inside thereof.

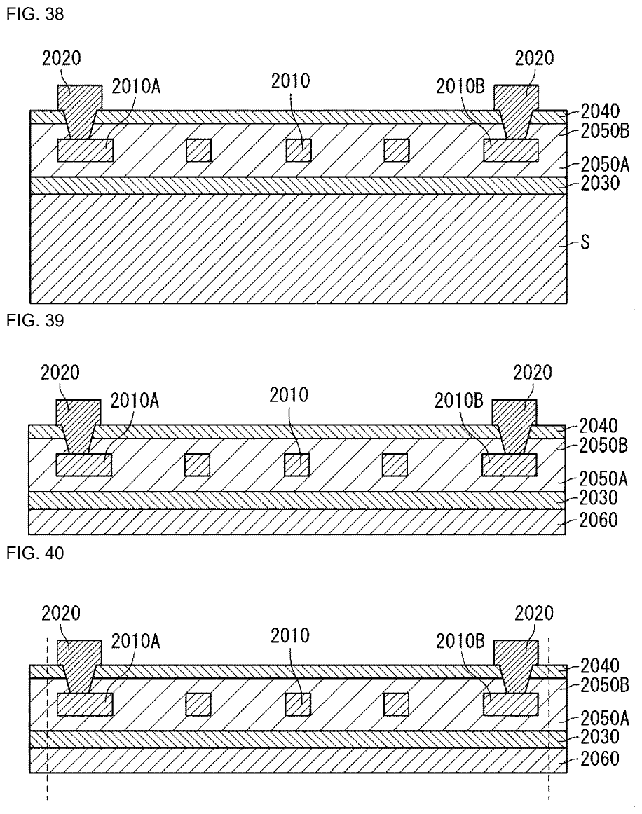

As shown in FIG. 38, step 8 of forming the vertical wires 2020 in the via holes BH formed in step 7 is performed. When laser light is irradiated to form the via holes BH, resin residue called smear is generated. First, a desmear treatment for removing the smear (resin residue) generated by the laser processing is performed. After the via holes BH are cleaned by the desmear treatment, the vertical wires 2020 are formed in the via holes BH. The vertical wire 2020 can be formed in the via hole BH by electrolytic plating similar to the above-described method of forming the inductor wire 2010. When electrolytic plating is used, the low-resistance vertical wires 2020 can be obtained at a low cost. The vertical wires 2020 can also be formed by a plating method other than electrolytic plating, a sputtering method, a vapor deposition method, a coating method, or the like.

As shown in FIG. 39, following step 8, step 9 of grinding the substrate material S to obtain the substrate 2060 having a predetermined thickness is performed. However, the configuration is not limited thereto. When the thickness of the substrate material S is a predetermined thickness in advance, the step 9 may be omitted. For example, when the first magnetic layer 2030 is formed on a temporary bonding layer provided on the substrate material S, the substrate material S can be removed from the first magnetic layer 2030 after steps 1 to 8 are performed. As a result, the inductor component 1 that does not include the substrate, as shown in FIG. 44, can be obtained.

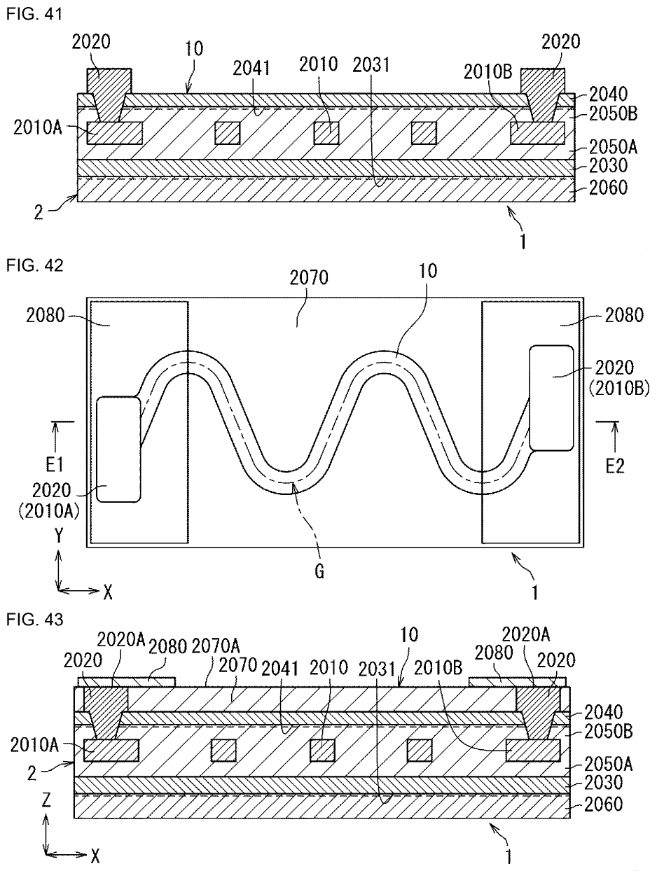

As shown in FIG. 40, following step 9 (or step 8 in some cases), step 10 of singulating the component using a cutting device is performed. FIG. 41 shows the inductor component 1 formed by singulation in step 10.

A modification of the inductor component 1 according to the second embodiment will be described with reference to FIGS. 42 to 45.

As shown in FIGS. 42 and 43, in a first modification of the inductor component 1, a third electrically insulating layer 2070, which is an inorganic electrically insulating layer, is further formed on the surface of the laminated second magnetic layer 2040. A region around the side surface of each of the vertical wires 2020, intersecting the first direction Z, is covered by the third electrically insulating layer 2070. The third electrically insulating layer 2070 may be formed of the same material as the first and second electrically insulating layers 2050A and 2050B, or may be formed of a different material.

In this way, since the side surface of each of the vertical wires 2020 is covered by the third electrically insulating layer 2070, current leakage to the second magnetic layer 2040 side and the like can be suppressed.

A surface 2070A of the third electrically insulating layer 2070 is formed to be at the same level as the end surfaces 2020A of the vertical wires 2020, and external terminals 2080 are formed to be in contact with the surface 2070A of the third electrically insulating layer 2070 and the end surfaces 2020A of the vertical wires 2020. The external terminal 2080 can be formed by electrolytic plating, sputtering, electroless plating, or the like, as in the case of the vertical wire 2020.

The external terminal 2080 is positioned so as to overlap the second magnetic layer 2040 when viewed in a direction perpendicular to the plane. In other words, in plan view, the external terminal 2080 extends to an outer side portion beyond the second magnetic layer 2040. In this way, since the inductor component 1 includes the external terminals 2080 connected to the vertical wires 2020 and extending along the plane and the external terminals 2080 are formed so as to overlap the second magnetic layer 2040 when viewed in a direction perpendicular to the plane, the size of each of the external terminals 2080 can be increased, so electrical resistance can be reduced, and the adhesion strength can be improved.

As shown in FIG. 44, in a second modification of the inductor component 1, the inductor component 1 does not include the substrate 2060. Since the substrate 2060 is not provided, the inductor component 1 can be made thinner. Furthermore, one of the vertical wires 2020 (the vertical wire on the left side in FIG. 44), as in the case of the above-described first modification, the vertical wire 2020 connected to the pad portion 2010A of the inductor wire 2010 is covered by the third electrically insulating layer 2070, and the external terminal 2080 is formed on the end surface 2020A of the vertical wire 2020.

Another vertical wire 2022 (the vertical wire on the right side in FIG. 44) is connected to the first magnetic layer 2030-side surface (the lower side in FIG. 44) of the pad portion 2010B of the inductor wire 2010. The other vertical wire 2022 penetrates the first magnetic layer 2030 and protrudes outward. In this way, in the second modification, the thin inductor component 1 can be achieved and can be connected to an external circuit from both above and below, so the flexibility of the mounting location is improved.

As shown in FIG. 45, in a third modification of the inductor component 1, the inductor component 1 includes the substrate 2060. One of the vertical wires 2020 (the vertical wire on the left side in FIG. 45), as in the case of the first and second modifications, is covered by the third electrically insulating layer 2070, and the external terminal 2080 is formed on the end surface 2020A of the vertical wire 2020.

The other vertical wire 2022 (the vertical wire on the right side in FIG. 45) is connected to the first magnetic layer 2030-side surface (the lower side in FIG. 45) of the pad portion 2010B of the inductor wire 2010, as in the case of the second modification. In the third modification, the other vertical wire 2022 penetrates the first magnetic layer 2030 and also penetrates the substrate 2060. The end surface 2022A of the other vertical wire 2022 is disposed at the same level as the surface of the substrate 2060 and is exposed to the outside.

In the third modification, since the vertical wire 2020 penetrates the substrate 2060, which is an inorganic substrate, connections to an external circuit can be performed from both above and below, so the flexibility of the mounting location is improved, and the strength of the substrate can be ensured with the presence of the inorganic substrate.

When the vertical wires 2020 and 2022 extend to both sides of the inductor wire 2010 as in the second and third modifications, connections to an external circuit can be performed from above and below, so the flexibility of the mounting location is improved.

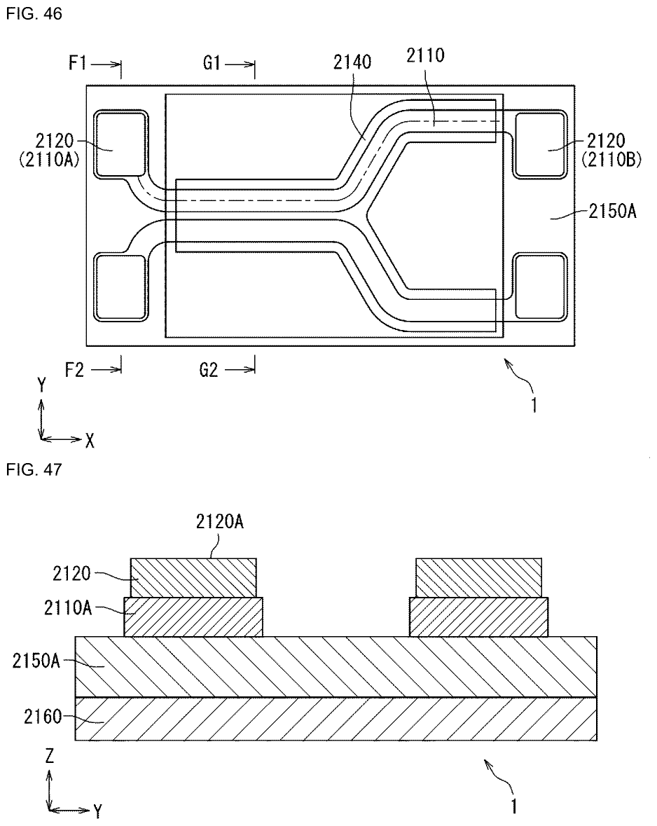

As shown in FIGS. 46 to 48, in a fourth modification of the inductor component 1, two inductor wires 2110 are disposed along the same plane. Each of the inductor wires 2110 is formed such that two regions extending parallel to one anisotropy-axis direction (for example, the X-axis direction) among the hard axis and the easy axis in uniaxial magnetic anisotropy are connected by a region extending in a direction intersecting the anisotropy-axis direction (for example, the X-axis direction). The region of the inductor wire 2110 extending in a direction intersecting one anisotropy-axis direction (for example, the X-axis direction) also extends without being orthogonal to one anisotropy axis (for example, the X-axis), as in the case of the first embodiment.

In the inductor component 1 according to the fourth modification as well, opposite ends of the inductor wire 2110 are spaced apart from each other in one anisotropy-axis direction (for example, the X-axis direction) among the hard axis and the easy axis in uniaxial magnetic anisotropy, and the inductor wire 2110 extends without being orthogonal to one anisotropy axis (for example, the X-axis) throughout the entire region.

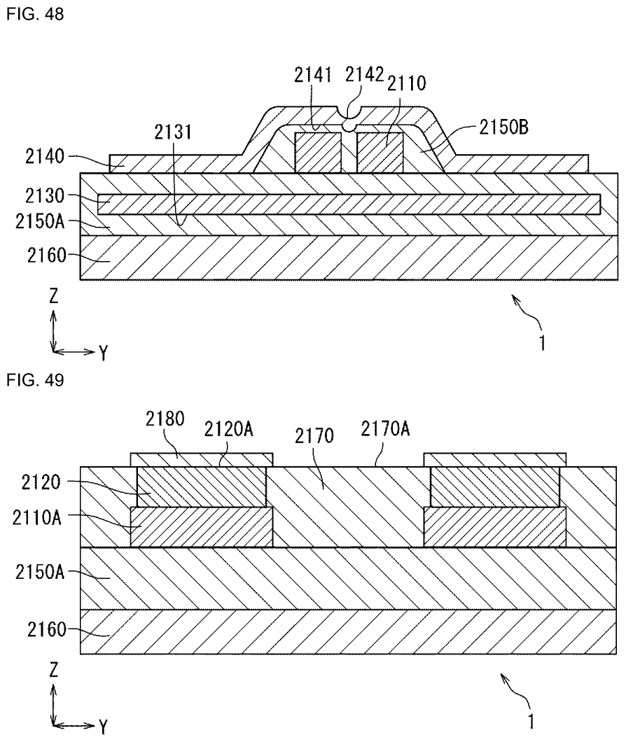

As shown in FIG. 48, a first electrically insulating layer 2150A is laminated on the substrate 2160, and the first magnetic layer 2130 is laminated so as to be positioned within the first electrically insulating layer 2150A. The inductor wires 2110 are formed on the first electrically insulating layer 2150A, and further, a second electrically insulating layer 2150B is further laminated so as to cover the inductor wires 2110, and the second magnetic layer 2140 is further laminated so as to cover the second electrically insulating layer 2150B. In the present embodiment, no electrically insulating layer is formed on the second magnetic layer 2140.

For example, the cross-sectional dimensions of each of the inductor wires 2110 may be 40 μm×20 μm, the thickness of the substrate 2160 may be 5 μm, and the thickness of each of the first magnetic layer 2130 and the second magnetic layer 2140 may range from 5 μm to 6 μm. The thickness of the first electrically insulating layer 2150A is a value obtained by adding about 2 μm to 10 μm to the thickness of the first magnetic layer 2130. The thickness of the second electrically insulating layer 2150B is a value obtained by adding about 2 μm to about 10 μm to the thickness of each of the inductor wires 2110. For example, the amount by which the vertical wire 2120 protrudes from the surface of the second magnetic layer 2140 may be 5 μm, and the dimensions of the inductor component 1, which has a substantially rectangular parallelepiped outer shape, may be L×W×T=1.0 mm×0.5 mm×0.5 mm. However, these dimensions are merely examples and are not limited thereto.

In the fourth modification, the number of inductor wires 2110 disposed along the same plane in one inductor component 1 is two; however, the number of inductor wires 2110 is not limited thereto. Three or more inductor wires 2110 may be disposed along the same plane. In this case, for example, a plurality of inductor components 1 is disposed symmetrically with respect to a center line extending along the long-side direction (for example, the X-axis direction) of the inductor component 1 having a rectangular planar shape.

In the fourth modification, since the plurality of inductor wires 2110 is disposed along the same plane, an inductor array element can be formed. Therefore, mounting interval can be omitted, so space saving is possible.

As shown in FIG. 46, the inductor component 1 has both a region in which the adjacent inductor wires 2110 are arranged parallel to each other and a region in which the adjacent inductor wires 2110 are arranged non-parallel to each other. With the non-parallel region, a region in which the adjacent inductor wires 2110 are arranged close to each other in parallel and a region in which the adjacent inductor wires 2110 are arranged apart from each other in parallel are formed. With such an arrangement, the coupling coefficient can be increased in the region in which the adjacent inductor wires 2110 are close to each other, and the coupling coefficient can be decreased in the region in which the adjacent inductor wires 2110 are arranged apart from each other. By connecting the regions in which the adjacent inductor wires 2110 are arranged parallel to each other with the non-parallel region, the coupling coefficient of the inductor can be variously controlled.

As shown in FIG. 48, in the region in which the adjacent inductor wires 2110 are close to each other, the second magnetic layer 2140 has a raised and recessed shape that covers the adjacent inductor wires 2110 from three directions. In this way, in a cross-sectional view of the inductor wires 2110 taken along the first direction Z, since the second magnetic layer 2140 has a raised and recessed shape that covers the inductor wires 2110 from three directions, one direction in the first direction Z and two directions in the second direction Y, the inductor wires 2110 can be covered all around together with the first magnetic layer 2130, so the efficiency of obtaining inductor is improved. In other words, in the inductor component 1 shown in FIG. 48, the second magnetic layer 2140 has a non-planar portion 2142 having a convex shape or concave shape relative to the first imaginary plane P1. With this configuration, leakage flux can be reduced, and the efficiency of obtaining inductance can be improved. The first magnetic layer 2130 may be configured to have a non-planar portion. The planar portion 2141 of the second magnetic layer 2140 is in contact with the non-planar portion 2142. A planar portion 2131 of the first magnetic layer 2130 is covered by the first electrically insulating layer 2150A. As shown in FIGS. 46 and 48, when viewed along the first direction Z, the second magnetic layer 2140 is provided inside the outer periphery of the inductor component 1. Therefore, during singulation, the magnetic layers are not likely to be damaged by cutting. For example, when the magnetic layers are elongated by mechanical stress during cutting, leakage may occur between the laminated magnetic layers, which increases iron loss; however, in the present embodiment, this can be avoided.

As shown in FIG. 47, the first magnetic layer 2130 and the second magnetic layer 2140 are not formed in the regions at opposite ends of the inductor wires 2110, in which the pad portions 2110A and 2110B are provided. Therefore, the vertical wires 2120 connected to the pad portions 2110A and 2110B do not penetrate the magnetic layers. In the present embodiment, the first magnetic layer 2130 and the second magnetic layer 2140 are disposed in a region other than opposite ends of the inductor wires 2110.

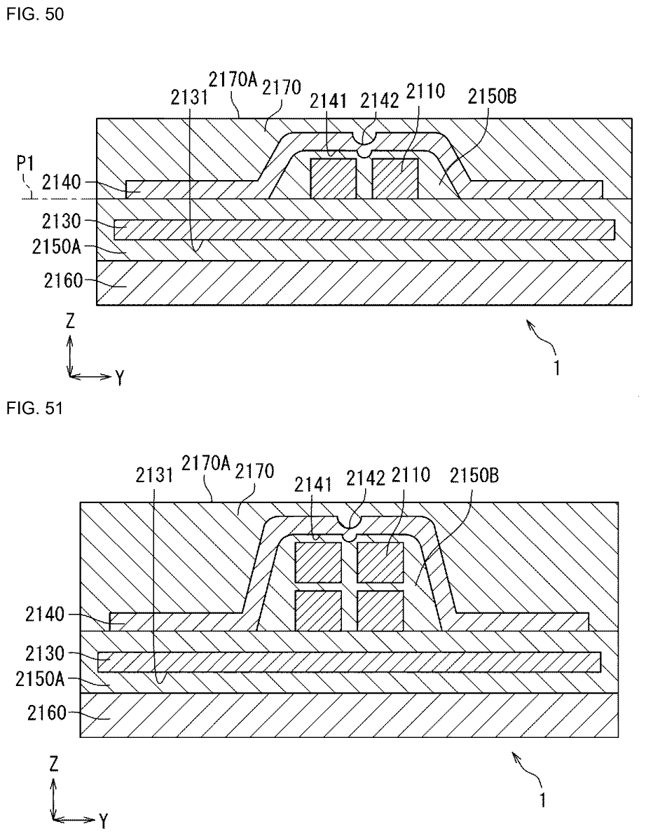

As shown in FIGS. 49 and 50, in a fifth modification of the inductor component 1, a third electrically insulating layer 2170, which is an inorganic electrically insulating layer, is further formed on the surface of the laminated second magnetic layer 2140. As shown in FIG. 49, a region around the side surface of the vertical wire 2120 is covered by the third electrically insulating layer 2170. As shown in FIG. 50, a region around the raised and recessed-shaped second magnetic layer 2140 having the non-planar portion 2142 is also covered by the third electrically insulating layer 2170. FIG. 49 is a cross-sectional view corresponding to FIG. 47, and FIG. 50 is a cross-sectional view corresponding to FIG. 48.

A surface 2170A of the third electrically insulating layer 2170 is formed to be at the same level as the end surface 2120A of the vertical wire 2120, and an external terminal 2180 is formed to be in contact with both the surface 2170A of the third electrically insulating layer 2170 and the end surface 2120A of the vertical wire 2120. The external terminal 2180 can be formed by electrolytic plating, sputtering, electroless plating, or the like, in the same manner as described above.

In the fifth modification of the inductor component 1, since the first magnetic layer 2130 and the second magnetic layer 2140 are covered by the first electrically insulating layer 2150A and the second electrically insulating layer 2150B, the first magnetic layer 2130 and the second magnetic layer 2140 can be protected from environmental load (such as humidity). Since the surface of the third electrically insulating layer 2170, which covers the second magnetic layer 2140 serving as the outermost surface of the inductor component 1, is formed to be flatter than the raised and recessed shape of the second magnetic layer 2140, coplanarity during mounting can be improved. Coplanarity refers to “being coplanar” and means a property or state in which a plurality of points exist on the same plane. Coplanarity may also be referred to as “surface uniformity” or “terminal flatness”.

As shown in FIG. 51, in a sixth modification of the inductor component 1, the inductor component 1 includes a plurality of layers in each of which the inductor wires 2110 are disposed along the first direction Z. In the inductor component 1 shown in FIG. 51, a layer composed of two inductor wires 2110 arranged along the same plane is formed in two layers in the first direction Z. In other words, in the cross-sectional view, the inductor wires 2110 are arranged in a 2×2 matrix. With this configuration, the line length of the inductor can be increased, so the flexibility of the coupling design can be improved. An electrically insulating material (second electrically insulating layer 2150B) is filled between the layers of the inductor wires 2110. However, the configuration is not limited thereto. A matrix-shaped inductor component 1 in which a selected number of inductor wires 2110 are arranged along the same plane in a selected number of layers may be adopted. In this way, when the inductor wires 2110 extending along the plane are formed in a plurality of layers and electrically insulating resin is filled between the layers of the inductor wires 2110, the flexibility of the inductor wires 2110 is improved. Furthermore, by filling electrically insulating resin between the inductor wires 2110, current leakage can be suppressed, so the inductor wires 2110 can be placed closer, with the result that the thin inductor component 1 can be realized.

In the present disclosure, any embodiment and/or modification among the above-described various embodiments and modifications may be combined as needed. The combinations of the embodiments and/or the modifications also include combinations of configurations included in the embodiments and/or the configurations included in the examples.

Although the present disclosure has been sufficiently described through the above-described embodiments and/or modifications with reference to the accompanying drawings, the above-described embodiments and/or modifications do not cover all aspects of the present disclosure. Various modifications and alterations will be apparent to those skilled in the art in the technical field of the present disclosure. Such modifications and alterations should be understood to be included within the scope of the present disclosure as long as the modifications and alterations do not fall outside the scope of the present disclosure.

What is claimed is:

1. An inductor element comprising:
a magnetic layer extending along a first imaginary plane, the magnetic layer having uniaxial magnetic anisotropy; and
an inductor wire spaced apart from the first imaginary plane in a first direction that intersects the first imaginary plane, the inductor wire extending along a second imaginary plane that is parallel to the first imaginary plane, wherein
a roughness of a planar portion of the magnetic layer on the first imaginary plane is from 3 nm to 10 nm.

2. The inductor element according to claim 1, wherein
the planar portion has the same roughness over an entire surface.

3. The inductor element according to claim 1, wherein
a portion of the inductor wire on the second imaginary plane has a roughness greater than the roughness of the planar portion.

4. The inductor element according to claim 1, further comprising:
an element body within which the magnetic layer and the inductor wire are located, wherein
the element body includes an electrically insulating layer that is in direct contact with the planar portion, and
a CTE of the electrically insulating layer is from 2 ppm/° C. to 60 ppm/° C.

5. The inductor element according to claim 1, further comprising:
an element body within which the magnetic layer and the inductor wire are located, wherein
the element body includes an electrically insulating layer that is in direct contact with the planar portion, and
a CTE of the electrically insulating layer is from 2 ppm/° C. to 35 ppm/° C.

6. The inductor element according to claim 1, further comprising:
an element body within which the magnetic layer and the inductor wire are located, wherein
the element body includes an inorganic material substrate.

7. The inductor element according to claim 6, wherein
the inorganic material substrate has a roughness less than the roughness of the planar portion.

8. An inductor component comprising:
the inductor element according to claim 1; and
an external terminal electrically connected to the inductor wire.

9. The inductor component according to claim 8, wherein
the inductor wire is a first inductor wire on one side of the magnetic layer in the first direction,
the inductor element includes
a second inductor wire on the other side of the magnetic layer in the first direction, and
a via portion electrically connecting the first inductor wire and the second inductor wire, and
the first inductor wire, the second inductor wire, and the via portion configure at least part of an inductor wound around an axis extending along a second direction that intersects the first direction.

10. The inductor component according to claim 9, wherein
an absolute value of an angle defined between a hard axis or easy axis of the magnetic layer and the axis is from zero degrees to smaller than 10 degrees.

11. The inductor component according to claim 9, wherein
the magnetic layer has a first end portion facing the via portion in a third direction that intersects the first direction and the second direction,
the via portion has a second end portion facing the magnetic layer in the third direction, and
the first end portion and the second end portion are inclined in the same direction relative to the first direction.

12. An inductor component comprising:
the inductor element according to claim 6;
a pad portion at an end of the inductor wire; and
a vertical wire connecting the pad portion and an external terminal.

13. The inductor component according to claim 12, further comprising:
a first magnetic layer that is the magnetic layer; and
a second magnetic layer extending along a third imaginary plane parallel to the first imaginary plane and the second imaginary plane, the second imaginary plane being between the first imaginary plane and the third imaginary plane in the first direction.

14. The inductor component according to claim 12, wherein
the inductor wire includes a plurality of layers extending along the first direction.

15. The inductor component according to claim 13, wherein
one of the first magnetic layer and the second magnetic layer has a non-planar portion with a convex shape or a concave shape relative to the first imaginary plane or the second imaginary plane.

16. The inductor component according to claim 13, wherein
a roughness of the planar portion of the first magnetic layer and a roughness of a planar portion of the second magnetic layer on the third imaginary plane are different.

17. The inductor element according to claim 2, wherein
a portion of the inductor wire on the second imaginary plane has a roughness greater than the roughness of the planar portion.

18. The inductor element according to claim 2, further comprising:
an element body within which the magnetic layer and the inductor wire are located, wherein
the element body includes an electrically insulating layer that is in direct contact with the planar portion, and
a CTE of the electrically insulating layer is from 2 ppm/° C. to 60 ppm/° C.

19. The inductor element according to claim 2, further comprising:
an element body within which the magnetic layer and the inductor wire are located, wherein
the element body includes an electrically insulating layer that is in direct contact with the planar portion, and
a CTE of the electrically insulating layer is from 2 ppm/° C. to 35 ppm/° C.

20. The inductor element according to claim 2, further comprising:
an element body within which the magnetic layer and the inductor wire are located, wherein
the element body includes an inorganic material substrate.
